(19) United States
(12) Patent Application Publication
(10) Pub. No.: US 2021/0241097 A1
(43) Pub. Date: Aug. 5, 2021

(54) Method and Apparatus for training an object recognition model

(71) Applicant: CANON KABUSHIKI KAISHA, Tokyo (JP)

(72) Inventors: Dongyue Zhao, Beijing (CN); Dongchao Wen, Beijing (CN); Xian Li, Beijing (CN); Weihong Deng, Beijing (CN); Jiani Hu, Beijing (CN)

(21) Appl. No.: 17/089,583

(22) Filed: Nov. 4, 2020

(30) Foreign Application Priority Data
Nov. 7, 2019 (CN) 201911082558.8

(51) Int. Cl. G06N 3/08; G06N 3/04; G06K 9/62

(52) U.S. Cl. CPC G06N 3/08; G06K 9/00221; G06K 9/6232; G06N 3/0481

(57) ABSTRACT

A training method and device for an object recognition model. An apparatus for optimizing a neural network model for object recognition, including a loss determination unit configured to determine loss data for features extracted from a training image set using the neural network model and a loss function with a weight function, and an updating unit configured to perform an updating operation on parameters of the neural network model based on the loss data and an updating function, wherein the updating function is derived based on the loss function with the weight function of the neural network model, and the weight function and the loss function change monotonically in a specific value interval in the same direction.

### CROSS REFERENCE TO RELATED APPLICATIONS

This application claims the benefit of Chinese Patent Application No. 201911082558.8, filed Nov. 7, 2019, which is hereby incorporated by reference herein in its entirety.

### FIELD OF THE INVENTION

The present disclosure relates to object recognition, and more particularly to a neural network model for object recognition.

### BACKGROUND

In recent years, object detection/recognition/comparison/tracking with respect to a still image or a series of moving images (such as a video) has been widely and importantly applied to and played an important role in the fields of image processing, computer vision and pattern recognition. The object may be a body part of a person, such as a face, a hand, a body, etc., other living beings or plants, or any other object that is desired to be detected. Face/object recognition is one of the most important computer vision tasks, and its goal is to recognize or verify a specific person/object based on the input pictures/videos.

In recent years, a neural network model for face recognition, especially a deep convolutional neural network (CNN) model, has reached breakthrough progress in significantly improving performance. Given a training data set, the CNN training process uses a general CNN architecture as a feature extractor to extract features from training images, and then calculates the loss data for supervised training of the CNN model by using various designed loss functions. So, when a CNN architecture is selected, the performance of the face recognition model is driven by the loss functions and the training data set. At present, a Softmax loss function and its variant (a boundary-based Softmax loss function) are commonly used as supervision functions in face/object recognition.

However, it should be pointed out that the training data sets are often not ideal, on the one hand, they do not fully demonstrate the real world, and on the other hand, the existing training data sets still contain noise samples even after data cleaning. For such training data sets, the existing Softmax loss function and its variants cannot achieve ideal results and cannot effectively improve the performance of the training model.

Therefore, there is a need for an improved technique to improve the training of object recognition models.

Unless otherwise stated, it should not be assumed that any of the methods described in this section are prior art just because they are included in this section. Also, unless otherwise stated, it should not be assumed that issues recognized with respect to one or more methods have been recognized in any prior art on the basis of this section.

### DISCLOSURE OF THE INVENTION

It is an object of the present disclosure to improve the training optimization of a recognition model for object recognition. Another object of the present disclosure is to improve image/video object recognition.

The present disclosure proposes improved training for a convolutional neural network model for object recognition, wherein, the optimization/updating amplitude, also known as the convergence gradient descent speed, for a convolutional neural network model is dynamically controlled during training, so as to adaptively match the progress of the training process, so that even for noisy training data sets, a high-performance training model can still be obtained.

The present disclosure also proposes using the model obtained through the above training process to perform object recognition, thereby further obtaining an improved object recognition result.

In one aspect, there provides an apparatus for optimizing a neural network model for object recognition, comprising: a loss determination unit configured to determine loss data for features extracted from a training image set using the neural network model and a loss function with a weight function, and an updating unit configured to perform an updating operation for parameters of the neural network model based on the loss data and an updating function, wherein the updating function is derived based on the loss function of the neural network model with the weight function, and the weight function and the loss function change monotonically in a specific value interval in the same direction.

In another aspect, there provides a method for training a neural network model for object recognition, comprising: a loss determination step of determining loss data for features extracted from a training image set using the neural network model and a loss function with a weight function, and an update step of performing an updating operation for parameters of the neural network model based on the loss data and an updating function, wherein the updating function is derived based on the loss function of the neural network model with the weight function, and the weight function and the loss function change monotonically in a specific value interval in the same direction.

In yet another aspect, there provides a device comprising at least one processor; and at least one storage device on which instructions are stored, the instructions, when executed by the at least one processor, causing the at least one processor to perform the method as described herein.

In yet another aspect, there provides a storage medium storing instructions that, when executed by a processor, cause execution of the method as described herein.

Other features of the present disclosure will become apparent from the following description of exemplary embodiments with reference to the accompanying drawings.

### DESCRIPTION OF THE DRAWINGS

A better understanding of the present disclosure may be obtained when considering following detailed description of embodiments in conjunction with the accompanying drawings. The same or similar reference numerals are used in the drawings to indicate the same or similar components.

FIG. 1 shows a schematic diagram of face recognition/authentication using a convolutional neural network model in the prior art.

FIG. 2A shows a flowchart of training a convolutional neural network model in the prior art.

FIG. 2B is a schematic diagram showing training results of a convolutional neural network model in the prior art.

FIG. 3A shows mapping of image feature vectors on a hyperspherical manifold.

FIG. 3B is a schematic diagram showing training results of image feature vectors when they are trained by a convolutional neural network model.

FIG. 3C shows a schematic diagram of training results of a convolutional neural network model according to the present disclosure.

FIG. 4A shows a block diagram of an apparatus for training a convolutional neural network model according to the present disclosure.

FIG. 4B shows a flowchart of a method for training a convolutional neural network model according to the present disclosure.

FIG. 5A shows graphs of an intra-class weight function and an inter-class weight function.

FIG. 5B shows finally adjusted graphs of the intra-class gradient and the inter-class gradient.

FIG. 5C indicates the optimized gradient being along the tangential direction.

FIG. 5D shows graphs of the intra-class gradient readjustment function and the inter-class gradient readjustment function with respect to parameters.

FIG. 5E shows the finally adjusted graphs of the intra-class and inter-class gradients with respect to the parameters.

FIG. 5F shows adjustment curves for intra-class gradients and inter-class gradients in the prior art.

FIG. 6 shows a basic conceptual flowchart of the convolutional neural network model training according to the present disclosure.

FIG. 7 shows a flowchart of the convolutional neural network model training according to the first embodiment of the present disclosure.

FIG. 8 shows a flowchart of the convolutional neural network model training according to a second embodiment of the present disclosure.

FIG. 9 shows a flowchart of adjusting parameters for a weight function in a convolution neural network model according to a third embodiment of the present disclosure.

FIG. 10 shows a flowchart of adjusting parameters for a weight function in a convolution application network model according to a fourth embodiment of the present disclosure.

FIG. 11 shows a flowchart of online training of a convolutional neural network model according to a fifth embodiment of the present disclosure.

FIG. 12 is a schematic diagram that an input image can be used as a suitable training sample for an object in a training data set.

FIG. 13 shows a schematic diagram that an input image can be used as a suitable training sample for a new object in a training data set.

FIG. 14 shows a block diagram of an exemplary hardware configuration of a computer system capable of implementing the embodiments of the present disclosure.

### DETAILED DESCRIPTION OF PREFERRED EMBODIMENTS

Described herein are exemplary possible embodiments related to model training optimization for object recognition. In the following description, for the purpose of explanation, numerous specific details are set forth in order to provide a thorough understanding of the present disclosure. However, it is apparent that the present disclosure can be practiced without these specific details. In other instances, well-known structures and devices are not described in detail to avoid unnecessarily blocking, covering, or obscuring the present disclosure.

In the context of the present disclosure, an image may refer to any one of a variety of images, such as a color image, a grayscale image, and the like. It should be noted that, in the context of this specification, the type of image is not specifically limited as long as such an image can be subjected to processing so that it can be detected whether the image contains an object. In addition, the image may be an original image or a processed version of the image, such as a version of an image that has undergone pre-filtering or pre-processing before operations of the present application are to be performed on the image.

In the context of this specification, an image containing an object means that the image contains an object image of the object. The object image may also be referred to as an object area in the image. Object recognition also refers to recognizing an image of an object area in an image.

In this context, an object may be a body part of a person, such as face, hands, body, etc., other living beings or plants, or any other object that is intended to be detected. As an example, features of an object, especially its representative features, can be represented in a vector form, which can be referred to as a “feature vector” of the object. For example, in the case of detecting a face, pixel texture information, position coordinates, and the like of a representative part of a human face are selected as features to constitute a feature vector of the image. Thus, object recognition/detection/tracking can be performed based on the obtained feature vector. It should be noted that the feature vector may be different depending on a model used in object recognition, and is not particularly limited.

Hereinafter, embodiments of the present disclosure will be described in detail with reference to the drawings. It should be noted that similar reference numbers and characters in the figures indicate similar items, and therefore once an item is defined in one figure, it need not be discussed for subsequent figures.

In the present disclosure, the terms “first”, “second”, and the like are only used to distinguish elements or steps, instead of being intended to indicate chronological order, preference, or importance.

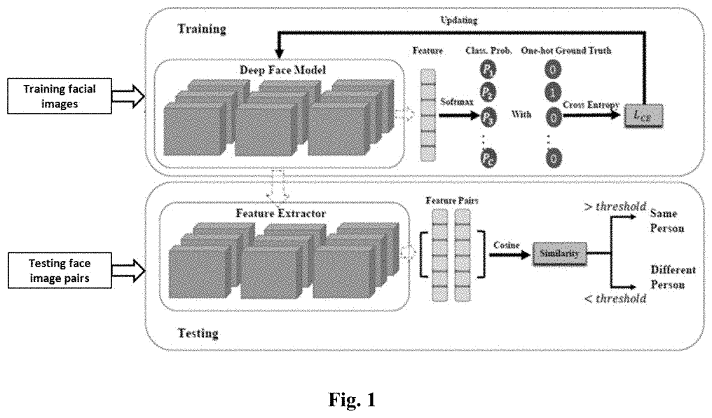

FIG. 1 shows basic conceptual operations of face recognition/authentication using a deep face model in the prior art, which mainly include a training stage and an application stage of the deep face model, and the deep face model may be, for example, a deep convolutional neural network model.

In the training stage, a face image training set is first input to a deep face model to obtain feature vectors of face images, and then, an existing loss function, such as a Softmax loss function and its variants, is used to obtain classification probabilities P₁, P₂, P₃, . . . , P_{c} (where c indicates the number of categories in the training set, such as face IDs corresponding to c categories) from the feature vectors, the classification probabilities indicating a probability that the image belongs to each of the c categories, and the obtained classification probabilities are compared with real situation values 0, 1, 0, . . . , 0 (where 1 indicates the true value) to determine the difference therebetween, such as cross entropy, as the loss data, and a feedback is performed based on the difference so as to update the deep face model, and then the foregoing operations resume by using the updated face model, until a specific condition is satisfied, thereby obtaining a trained deep face model.

In a test stage, a face image to be identified or a face image to be authenticated may be input into a trained deep face model to extract features for identification or authentication. Specifically, in an actual application system, there can be two specific applications: face/object recognition and face/object verification. The input to face/object recognition is generally a single face/object image. The trained convolutional neural network is used to identify whether the face/object in the current image is the recognized object; the input to face/object verification is generally a pair of person face/object images, the trained convolutional neural network is utilized to extract feature pairs of the input pair of images, and finally, whether the input pair of images correspond to the same object is determined based on similarity of the feature pairs.

An exemplary face authentication operation is shown in FIG. 1. In operation, two face images to be authenticated are input into a trained deep face model to authenticate whether the two face images are face images of the same person. Specifically, the deep face model may obtain feature vectors for the two face images individually to form a feature vector pair, and then determine similarity between the two feature vectors, for example, the similarity may be determined by a cosine function. When the similarity is not less than a specific threshold, the two face images may be considered to be face images of the same person, and when the similarity is less than the specific threshold, the two face images may be considered not to be face images of the same person.

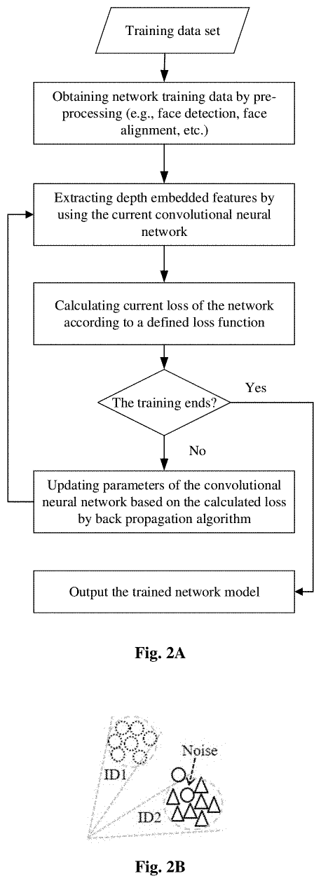

As can be seen from the above description, the performance of the deep face model directly affects the accuracy of object recognition, and in the prior art, various methods have been utilized to train the deep face model, such as a deep convolutional neural network model, to obtain a more complete depth convolutional neural network model. A training process for a deep convolutional neural network model in the prior art will be described below with reference to FIG. 2A.

First, a training data set is input, and the training data set may include a large number of object images, such as face images, for example, tens of thousands, hundreds of thousands, millions of object images.

Then, the images in the input training data set may be pre-processed, and the pre-processing operations may include, for example, object detection, object alignment, normalization, and the like. In particular, the object detection may refer to, for example, detecting a human face from an image containing the human face and obtaining an image mainly containing the human face to be identified, and the object alignment may refer to aligning object images in different poses included in the images to the same or appropriate posture, thereby object detection/recognition/tracking can be performed based on the aligned object images. Face recognition is a common object recognition operation, and for the face recognition training image set, a variety of preprocessing including, for example, face detection, face alignment, and the like can be performed. It should be noted that the pre-processing operation may also include any other type of pre-processing operations known in the art, which will not be described in detail here.

Then, the pre-processed training image set is input to a deep convolutional neural network model for feature extraction. The convolutional neural network model can adopt various structures and parameters known in the art, etc., which will not be described in detail here.

Then, a loss is calculated by means of a loss function, especially the above-mentioned Softmax loss function and its variants. The Softmax loss function and its variant (boundary-based Softmax loss function) are commonly used supervised information in the face/object recognition. These loss functions encourage separation between features, and the goal is to ideally minimize the intra-class distance while maximizing the inter-class distance. A general form of the Softmax loss function is as follows:

$$L = - \frac{1}{N} {{\sum }_{i}}^{N} log \frac{{e}^{{w}_{{y}_{i}} {T}_{{x}_{i} + {b}_{{y}_{i}}}}}{{\sum }_{j = 1}^{C} {e}^{{w}_{j} {T}_{{x}_{i} + {b}_{j}}}} \qquad ( 1 )$$

Where xᵢ∈ [symbol] ^{d} is the embedded feature of the ith training image, yᵢ is the category label for xᵢ, C is the number of categories in the training data set, W={W₁, W₂, . . . , W_{C}}∈ [symbol] ^{d×C} represents the weight for the last fully connected layer in the DCNN, and Wⱼ∈ [symbol] ^{d} a is a weight vector for the jth column of the last fully connected layer in the DCNN, bⱼ∈R^{C} is a bias term. In the prior art, a loss function based on Softmax removes the bias term therefrom and is converted to Wⱼ^{T}xᵢ=s cos θⱼ. L indicates probability.

Then, the parameters of the convolutional neural network are updated by back propagation according to the calculated loss data.

However, the prior art methods all assume that an operation that the intra-class distance is minimized while the inter-class distance is maximized is strictly performed given an ideal training data set, so the loss functions used are designed to strictly minimize the intra-class distance and maximize the inter-class distance, and in this way, a convergence gradient used in the updating/optimization during model training has a fixed scale. This may cause overfitting due to defects in the current training data set, such as interference from noise samples.

Specifically, in the training process, the existing training method first learns features of clean samples so that the model can effectively identify most of the clean samples; and then continuously optimizes the noise samples along the gradient direction. However, regardless of the current distance between the training samples, the convergence gradient for the optimization has a fixed scale. In this way, the samples with noise may also travel in the wrong direction at a constant speed, and in the late stage of training, the noise samples will be incorrectly mapped to the feature space areas of other objects, causing the model to overfit. As shown in FIG. 2B, the noise samples are included in the W2 type samples corresponding to ID2 as the training set is processed, and cannot be effectively separated from the clean samples. As a result, the training effect is not always optimal, which adversely affects the trained model, and may even lead to misrecognition of the face image of ID2.

In addition, the loss function employed in the prior art model training process performs a relatively complex transformation on the extracted features, for example, the transformation from the domain of feature vectors to the probability domain. Such transformation inevitably introduces certain transformation errors. This can lead to reduced accuracy and increased computational overhead.

Moreover, the loss functions used in the prior art model training process, such as the Softmax loss function and its variants, all mix the intra-class distance and inter-class distance to calculate the probability, so that the intra-class distance and inter-class distance are mixed together, which is not convenient for providing targeted analysis and optimization, and may cause the convergence of model training to be inaccurate and fail to obtain a further optimized model.

The present disclosure is proposed in view of the above issues in the prior art. In the model optimization method in the present disclosure, it is possible to dynamically control the model updating/optimization amplitude during the model training process, especially the convergence gradient descent speed. In particular, the convergence gradient descent speed can adaptively match the progress of the training process, especially dynamically change as the training process goes on, and especially converge more slowly or even stop when the best training results are approached.

This can prevent overfitting of noise samples, so as to ensure that the model training can effectively adapt to the training data set, so that a high-performance training model can be obtained even for a training data set containing noise. That is, even for a training data set that may contain noisy images, the noisy images can still be effectively separated from clean images, and overfitting can be suppressed as much as possible, so that the model training is further optimized to obtain an improved recognition model, and thus better face recognition results can be obtained.

In the following, specific parameters involved in the training of the deep convolutional neural network model according to the present disclosure, among which an image feature vector, an intra-class loss, and an extra-class loss, etc. are particularly involved, will be exemplarily explained with reference to the accompanying drawings.

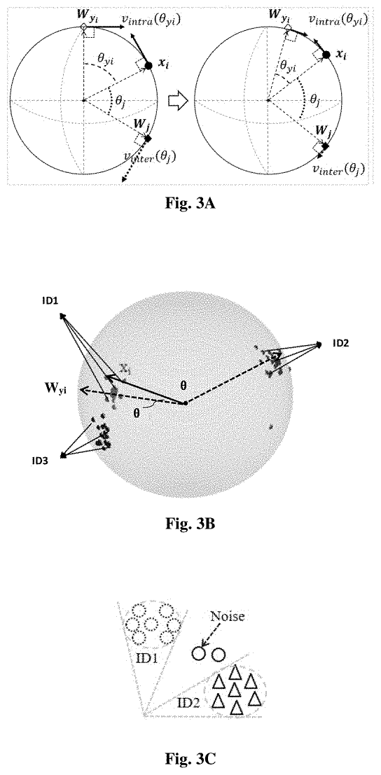

In the implementation of the present disclosure, the depth-embedded features of all training samples are mapped onto a hyperspherical manifold, where xᵢ∈ [symbol] ^{d} represents the embedded feature of the i-th training image, yᵢ is the category label of xᵢ, W_{y}_{ᵢ}∈ [symbol] ^{d} is the target center feature of the category yᵢ, θ_{yi} is the angle between xᵢ and the target center feature W_{y}_{ᵢ}. Wⱼ is the target center feature of another category, and θj is the angle between xᵢ and the target center feature Wⱼ of the another category. vᵢₙₜᵣₐ (θ_{yi}) is the scale of the intra-class gradient, and vᵢₙₜₑᵣ (θᵢ) is the scale of the inter-class gradient. The longer the arrow is, it is indicated that the larger the gradient is, as shown in FIG. 3A. The optimization direction of gradient always moves along the tangent of the hypersphere, wherein the movement direction of the intra-class gradient indicates that it is intended to reduce the intra-class angle, and the direction of the inter-class gradient of the class indicates that it is intended to increase the inter-class angle. Based on such a mapping process, the intra-class angle and inter-class angle can be adjusted as the intra-class distance and the inter-class distance, respectively.

According to the implementation of the present disclosure, an improved weight function is proposed for dynamically controlling the model updating/optimization amplitude during the training process, that is, the convergence gradient descent speed.

In order to constrain the optimization amplitude, the design idea of the weight function of the present disclosure is to design a mechanism which is effective for limiting the magnitude of the gradient, that is, it can flexibly control the gradient convergence speed suitable for a training data set with noise. That is to say, through usage of weight functions, variable amplitudes can be used to control the training convergence during training the convolutional neural network model, and the convergence speed will be slower and slower or even stop when the optimal training result is approached, therefore, instead of forcing fixed convergence as in the prior art, the convergence can appropriately stop or slow down, avoiding overfitting of noisy samples and ensuring that the model can effectively adapt to the training data set, thereby improving the performance of model training in terms of generalization.

FIG. 3B shows a schematic diagram of training results of a convolutional neural network model according to the present disclosure, where the category features are effectively separated without causing overfitting. Specifically, during the training process, the convergence is strong in the early stage of iteration. As the iterative process proceeds, the gradient convergence ability becomes smaller and smaller in the middle stage of training, and finally the gradient convergence almost stops in the late stage of training, so that the noise features will not affect the trained model.

FIG. 3C shows a basic situation after classification, where ID1, ID2, and ID3 respectively indicate three categories, wherein the features of the training images of the same category are gathered as much as possible, that is, the intra-class angle is as small as possible, and the features of training images of different categories are separated as much as possible, that is, the inter-class angle is as large as possible.

Embodiments of object recognition model training of the present disclosure will be described below with reference to the drawings.

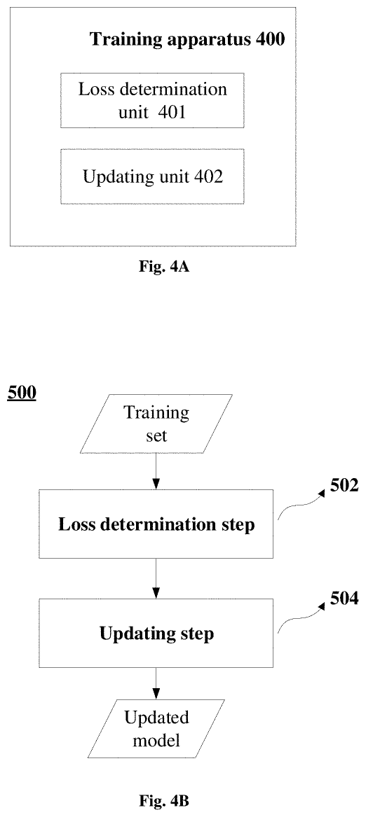

FIG. 4A illustrates a block diagram of an apparatus for optimizing a neural network model for object recognition according to the present disclosure. The apparatus 400 includes a loss determination unit 401 configured to determine loss data for features extracted from a training image set using the neural network model and a loss function with a weight function, and an updating unit 402 configured to perform an updating operation for parameters of the neural network model based on the loss data and an updating function, wherein the updating function is derived based on the loss function of the neural network model and the corresponding weight function, and the weight function and the loss function change monotonically in a specific value interval in the same direction.

In an embodiment of the present disclosure, the neural network model may be a deep neural network model, and the acquired image features are deep embedded features of the images.

The weight function of the present disclosure will be described below with reference to the drawings.

In the present disclosure, in a case where the depth-embedded features of the training samples are mapped to the hyperspherical manifold as shown in FIG. 3A, the weight function can constrain the optimal gradient directions of the training samples and the target center to always follow the tangent of the hypersphere.

According to an embodiment of the present disclosure, the weight function and the loss function may both be functions of angles, where the angles are angles between the extracted features mapped onto the hyperspherical manifold and a specific weight vector in the fully connected layer of the neural network model. In particular, the specific weight vector may be a feature center of a certain category of objects in the training image set. For example, for the features extracted from the training images, the specific weight vector may include the target feature center of the category to which the training images belongs or the target feature centers of other categories, and accordingly, the intersection angle may include at least one of the intra-class angle and the inter-class angle.

Therefore, the intersection angle between the feature vectors can be directly optimized as the target of the loss function, without needing to convert the feature vectors into cross entropies and use the loss of the cross entropies as the loss function as in the prior art, thereby ensuring the target of the loss function is consistent with the goal of the prediction process. Specifically, the target of the loss function can be the angle between specific object vectors, and in the prediction stage, such as the aforementioned object verification stage, based on the angle between the extracted two object feature vectors, it is determined that whether they correspond to the same object. In this case, the goal of the prediction process is also an angle, so the target of the loss function can be consistent with the goal of the prediction process. In this way, the operations of determining the loss data and performing feedback based thereon can be simplified, intermediate conversion processing can be reduced, calculation overhead can be reduced, and calculation accuracy can be prevented from being deteriorated.

According to an embodiment of the present disclosure, the weight function is in correspondence with the loss function. According to an embodiment of the present disclosure, in a case where the loss function includes at least one sub-function, the weight function may correspond to at least one of the at least one sub-function included in the loss function. As an example, the weight function may be one weight function corresponding to one of the at least one sub-function included in the loss function. As another example, the weight function may include more than one sub-weight functions corresponding to more than one sub-functions included in the loss function, where the number of the more than one sub-weight functions is the same as that of the more than one sub-functions.

According to the embodiments of the present disclosure, the same-direction monotonic change means that the weight function and the loss function change in a specific value interval in the same direction as the value changes, for example, increase or decrease in the same direction as the value increases. According to an embodiment of the present disclosure, the specific value interval may be a specific angle value interval, in particular, an angle interval for optimization corresponding to the intra-class angle or the inter-class angle. Preferably, in the case of the hyperspherical manifold mapping as described above, the intra-class angle and the inter-class angle may be optimized in [0, π/2], so the specific angle value interval is [0, π/2], and preferably, the weight function and the loss function may monotonically change in the specific angle value interval in the same direction, and may monotonically and smoothly change in the same direction.

According to the embodiments of the present disclosure, the weight function may be any of various types of functions, as long as it can monotonously change in the specific angle value interval in the same direction as the loss function, and has cut-off points near two end points of the value interval. In particular, the slope of curve is substantially zero at the end points of the value interval.

According to the embodiments of the present disclosure, the weight function may be a Sigmoid function or a similar function, and it can be expressed as:

$$a . \frac{S}{1 + {e}^{- n * ( θ - m )}}$$

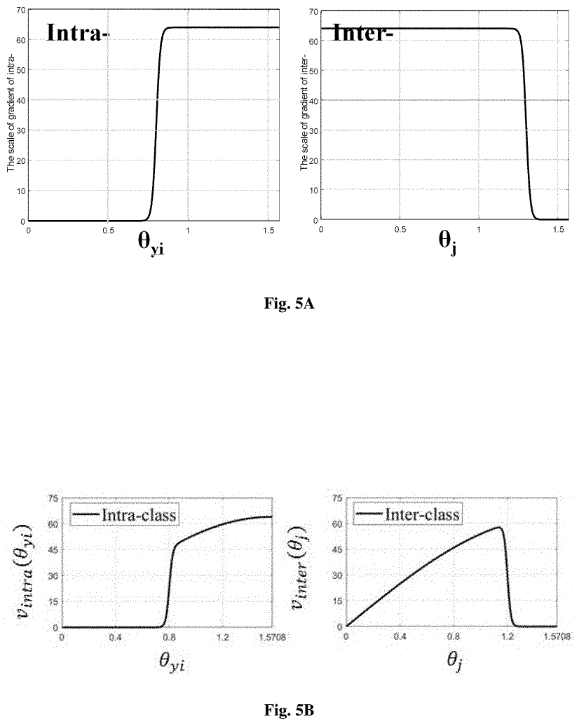

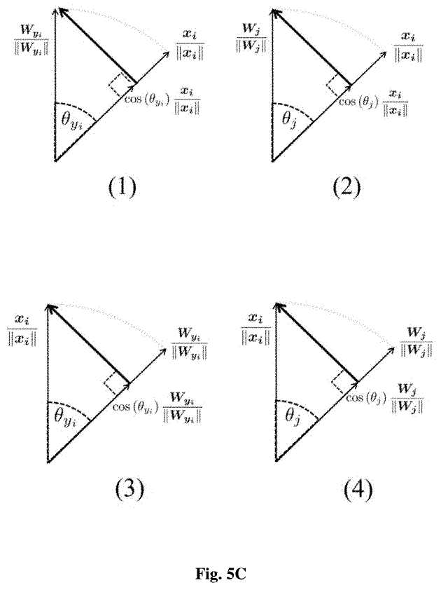

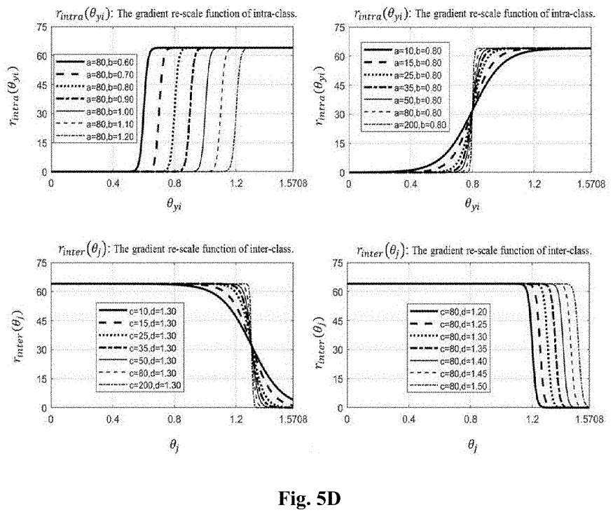

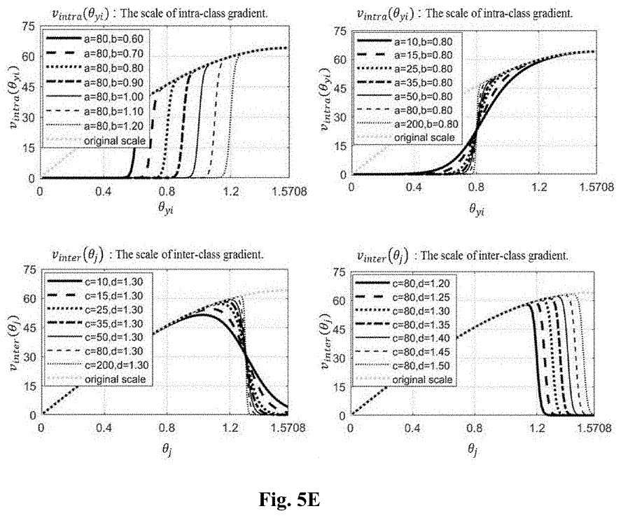

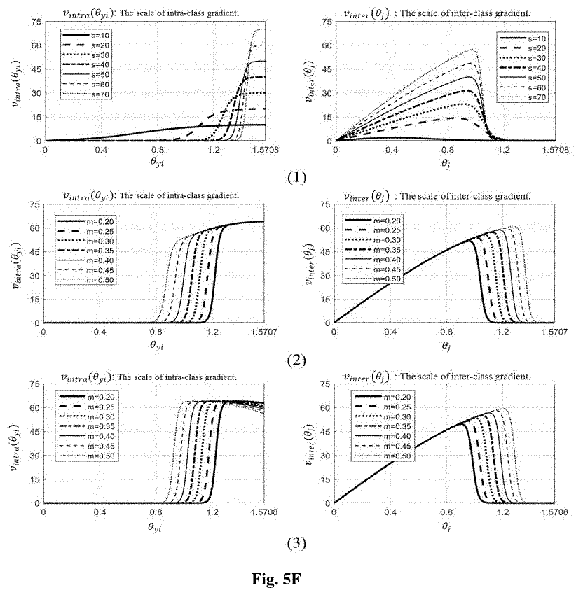

Among them, S is an initial scale parameter that controls the gradient of the Sigmoid curve; n and m are parameters that control the slope and horizontal intercept of the Sigmoid curve, respectively. These parameters actually control a flexible interval to suppress the movement speed of the gradient. Thus, a scalar function of an angle can be obtained from the weight function to readjust the optimization target, that is, the angle. Graphs of possible weight functions are shown in FIG. 5A, which monotonically increase or monotonically decrease between 0 and π/2, while maintaining a substantially constant value near the end points close to 0 and π/2, where the left graph can refer to a weight function for intra-class loss, and the right graph can refer to a weight function for inter-class loss. The horizontal axis indicates the range of angle value, such as about 0 to 1.5, and the vertical axis indicates the range of scale, for example, about 0 to 70, and for example, may also be similar to the values in FIGS. 5D to 5E, but it should be noted that the values are only exemplary, which will be described in detail below.

According to one implementation, since the original loss's gradient magnitude is related to the sine function of the angle, the final gradient magnitude is also proportional to a combination (e.g., the product) of the weight function and the sine function. Therefore, in the case that the weight function is such a Sigmoid function or the like, the magnitude of the convergence gradient during the updating process can be determined accordingly, as shown in FIG. 5B, where the graph on the left can refer to the magnitude of the convergence gradient of the intra-class loss, and the graph on the right can refer to the magnitude of the convergence gradient of the inter-class loss. The horizontal axis indicates the range of angle value, and the vertical axis indicates the range of scale. The values are only exemplary, and may be similar to the values in FIGS. 5D to 5E, for example.

According to an embodiment of the present disclosure, the parameters of the weight function may be set/selected according to average performance of the training data and the verification data. According to an embodiment of the present disclosure, parameters of the weight function, including a slope parameter and an intercept parameter, for example, at least one of the parameters n, m, and the like in the above-mentioned Sigmoid function or the like, may be adjusted.

According to an embodiment of the present disclosure, after around of training (which may have passed a specific number of iterations), it may be determined, based on a specific condition, whether the parameters are to be further adjusted. As an example, the specific condition may be related to the training result or the number of adjustments. As an example, the parameter adjustment may no longer be performed when a predetermined number of adjustments is reached. As another example, the selection can be made based on a comparison between a current training result and a previous training result. The training result may be, for example, loss data determined by a model determined by the current training. If the current training result is worse than the previous training result, the parameters will not be adjusted, and if the current training result is better than the previous training result, the parameters can continue to be adjusted according to the previous parameter adjustment mode, until the predetermined number of adjustments is reached or the training result does not become better.

According to an embodiment of the present disclosure, it is possible to set two initial values for one parameter of a weight function, and then use each parameter value to perform iterative loss data determination and updating operations, and after one round of training for each parameter completes, a parameter value that leads to a better training result (for example, the loss data caused by the trained model) is chosen, and two parameter values around the chosen parameter value are set as parameters for the weight function used in the next round of training operation. Such process is repeated until the predetermined number of adjustments is reached or the training result is no longer better. As an example, for a parameter n of the weight function, its initial values can be set to 1 and 1.2, and after a round of iteration, it is found that the parameter of n=1 can achieve a better result, then the value of n can be further set to 0.9 and 1.1, and subsequent iterations and adjustments are repeated until a predetermined number of adjustments are reached or the training result is no longer better.

According to the embodiment, multiple parameters in the weight function can be adjusted in various ways. As an example, the adjustment can be performed on a parameter-by-parameter basis, that is, after the adjustment for one parameter is completed, another parameter is adjusted, each parameter can be adjusted as described above, and during its adjustment, other parameters can be kept fixed. In particular, for the above Sigmoid function or the like, the slope parameter can be adjusted first, and then the intercept parameter can be adjusted. As another example, multiple parameters can be adjusted at the same time, for example, each parameter can be adjusted in the same way as that for the previous adjustment, so that a new set of parameter values can be obtained and used for subsequent training.

For example, two initial sets of values, that is, the first set of values and the second set of values, can be set for the hyperparameters and each set of initial values can be utilized to perform model training to obtain a performance of a corresponding validation data set. By comparing the obtained performances of validation data sets, the better performance is selected, and two sets of improved parameter values are set near the initial parameter values corresponding to the better performance, and such two sets of improved parameter values are utilized again to perform model training, the iteration continues until the most appropriate hyperparameter location is determined.

The loss function according to the present disclosure will be described below.

According to an embodiment of the present disclosure, a loss function for calculating the loss data is not particularly limited. As an example, a general loss function may be employed to calculate the loss data, and the loss function may be, for example, an original loss function for a neural network model, and may be related to an intersection angle.

According to an embodiment of the present disclosure, the loss function is a function that changes substantially monotonically within a specific value interval. As an example, in a case that the specific value interval is a specific angle value interval [0, π/2], the loss function can be a cosine function of the intersection angle, and accordingly, the weight function may also monotonously change within the specific value interva in the same direction as the loss function.

According to another implementation of the present disclosure, a new loss function determined based on the weight function according to the present disclosure is proposed, whereby the loss function can be used to obtain loss data during training the object recognition model, and the model can be updated/optimized based on the loss data and the weight function, so that the updating/optimization amplitude for the model can be further adaptively controlled and the updating/optimization of the model can be improved. According to one embodiment, the loss function used to calculate the loss data may be a combination of a loss function of a neural network model and a weight function. According to one embodiment, the loss function used to calculate the loss data may be the product of the loss function of the neural network model and the weight function. In particular, the loss function of the neural network model here refers to an original loss function that is not weighted by the weight function, and the loss function used to calculate the loss data may refer to a weighted function obtained by weighting the original loss function by the weight function.

According to an embodiment of the present disclosure, the loss data to be considered may include both intra-class loss and inter-class loss. Thus, the loss function used for model training may include two sub-functions: an intra-class loss function and an inter-class loss function. In the case of the aforementioned hyperspherical manifold mapping, such two sub-functions may be related to the angle, which are the intra-class angle loss function and the inter-class angle loss function, respectively. Therefore, analysis and optimization can be performed for the intra-class loss and the inter-class loss individually, so that the intra-class gradient term and the inter-class gradient term can be decoupled, which helps to analyze and optimize the intra-class loss term and the inter-class loss term, individually.

According to the implementation of the present disclosure, the loss function of the present disclosure may include an intra-class loss function and an inter-class loss function, and at least one of the intra-class loss function and the inter-class loss function may have a weight function corresponding thereto, so that in the object recognition model training, the weight function can be used to update/optimize the model. For example, for the intra-class loss or inter-class loss, the intra-class updating function or inter-class updating function determined based on the weight function can be utilized for model updating/optimization, thereby improving the control for model updating/optimization to a certain extent.

According to the implementation of the present disclosure, the loss function of the present disclosure may include an intra-class loss function and an inter-class loss function, and at least one of the intra-class loss function and the inter-class loss function is determined based on a weight function corresponding thereto. Therefore, the at least one of the intra-class loss function and the inter-class loss function can be a weighted function weighted by a corresponding weight function. Preferably, both the intra-class loss function and the inter-class loss function included in the loss function may be weighted functions which are weighted by corresponding weight functions.

According to an embodiment of the present disclosure, the loss function includes an intra-class angle loss function, wherein an intra-class angle is an intersection angle between an extracted feature mapped onto a hyperspherical manifold and a specific weight vector in a fully connected layer of the neural network model representing a truth object, and wherein the updating function is determined based on the intra-class angle loss function and the weight function for the intra-class angle.

According to the embodiments of the present disclosure, the intra-class angle loss function mainly aims to optimize the intra-class angle, particularly reduce the intra-class angle moderately, and thus the intra-class angle loss function shall decrease as the intra-class angle decreases. That is, the intra-class angle loss function should be a function that monotonically increases over a specific value interval. Correspondingly, the weight function for the intra-class angle is a function which is non-negative and monotonically increases, preferably smoothly and monotonically increases, over a specific value interval.

As an example, the range of the intra-class angle is [0, π/2]. The intra-class angle loss function may be a cosine function of the intra-class angle, particularly a cosine function of the intra-class angle that takes a negative value, and the weight function for the intra-class angle has a horizontal cutoff point near 0.

As an example, the intra-class angle loss function can be—cos(θ_{y}_{ᵢ})=W_{y}_{ᵢ}^{T}xᵢ/∥W_{y}_{ᵢ}∥∥xᵢ∥, θ_{y}_{ᵢ} is the intra-class angular distance between xᵢ/∥xᵢ∥ and W_{yi}/∥W_{y}_{ᵢ}∥.

As another example, the intra-class angle loss function may be Lᵢₙₜᵣₐ(θ_{y}_{ᵢ})=−[rᵢₙₜᵣₐ(θ_{y}_{ᵢ})]_{b} cos(θ_{y}_{ᵢ}) which is determined based on a weight function, where rᵢₙₜᵣₐ(θ_{y}_{ᵢ}) is a gradient re-adjustment function for an intra-class angle, which corresponds to the weight function of the present disclosure, and [rᵢₙₜᵣₐ(θ_{y}_{ᵢ})]_{b} is a block gradient operator used for weighting the intra-class angular distance loss during the training process, and during each training iteration, its constant value is calculated for weighting, and its contribution is not taken into account when the gradient is calculated in a later stage.

According to an embodiment of the present disclosure, the loss function further includes an inter-class angle loss function, and wherein an inter-class angle is an intersection angle between an extracted feature mapped onto a hyperspherical manifold and another weight vector in a fully connected layer of the neural network model, and wherein the updating function is determined based on the inter-class angle loss function and the weight function for the inter-class angle.

According to the embodiments of the present disclosure, the inter-class angle loss function mainly aims to optimize the inter-class angle, particularly increasing the inter-class angle appropriately, and thus the inter-class angle loss function should decrease as the inter-class angle increases. That is, the inter-class angle loss function shall be a function that monotonically decreases over a specific value interval.

Correspondingly, the weight function for the inter-class angle is a function which is non-negative and monotonically decreases, preferably smoothly monotonically decreases, over a specific value interval.

As an example, the range of the inter-class angle value is [0, π/2]. The inter-class angle loss function may be a cosine function of the inter-class angle, and the weight function for the inter-class angle has a horizontal cut-off point around π/2.

As an example, the inter-class angle loss function may be Σ_{j=1,j≠y}_{ᵢ}^{C} cos(θⱼ), where cos(θⱼ)=Wⱼ^{T}xᵢ/∥ⱼ∥∥xᵢ∥, j≠yᵢ, θⱼ(j≠yᵢ) is the inter-class angular distance between xᵢ/∥xᵢ∥ and Wⱼ/∥Wⱼ∥. Here, C is the number of categories in the training image set.

As another example, the inter-class angle loss function may be Lᵢₙₜₑᵣ(θⱼ)=Σ_{j=1,j≠y}_{ᵢ}^{C}[rᵢₙₜₑᵣ(θⱼ)]_{b} cos(θⱼ) which is determined based on a weight function, where rᵢₙₜₑᵣ(θⱼ) is a gradient re-adjustment function for the inter-class angle, which corresponds to the weight function of the present disclosure, and [rᵢₙₜₑᵣ(θⱼ)]_{b} is a block gradient operator used for weighing the inter-class cosine angular distance loss, and during each training iteration, its constant value is calculated for weighting, and its contribution is not taken into account when the gradient is calculated in a later stage.

The operations of the updating function and the updating unit according to the present disclosure will be described below.

According to an embodiment of the present disclosure, the updating function may be determined based on a loss function and a weight function. According to one embodiment, the updating function may be based on a partial derivative of the loss function and the weight function. Preferably, the updating unit is further configured to multiply the partial derivative of the loss function with the weight function to determine an updating gradient for updating the neural network model. It should be noted that as an example, the loss function described herein may refer to an initial loss function in a neural network model, such as a loss function that is not weighted by a weight function.

According to an embodiment of the present disclosure, in a case where the loss function includes at least one sub-loss function, the updating function may be determined based on at least one of the at least one sub-loss function, such as its partial derivative, and a weight function corresponding thereto. As an example, the updating function may be determined based on one of the at least one sub-loss function, such as its partial derivative, and a weight function corresponding to the one sub-loss function. As another example, the updating function may be determined based on more than one sub-loss functions, such as their partial derivatives, and weight functions corresponding to the more than one sub-loss functions respectively.

According to an embodiment of the present disclosure, the updating unit is further configured to update the parameters of the neural network model using a back propagation method and the determined updating gradient. After the neural network model is updated, the updating unit will operate by using the updated neural network model.

According to an embodiment of the present disclosure, when the loss data determined after updating the neural network model is greater than a threshold, and the number of iteration operations performed by the loss determination unit and the updating unit does not reach a predetermined number of iterations, the updating unit will proceed to a next iterative updating operation, until the determined loss function is less than or equal to the threshold, or the number of iteration operations reaches the predetermined number of iterations. As an example, the updating unit may include a judgement unit configured to judge whether the loss data is greater than the threshold, and/or judge whether the number of iteration operations has reached the predetermined number of times, and a processing unit configured to perform the updating operation according to the judgement result.

Exemplary implementations of a loss function according to the present disclosure including both an intra-class loss function and an inter-class loss function and their corresponding weight functions will be described below.

In order to constrain the degree of optimization, the idea of the loss function of the present disclosure is to provide a mechanism effective for limiting the gradient magnitude, which can properly constrain/control the reduction of the intra-class angle and the increasement of the inter-class angle during the training process. Therefore, a new loss function (SFace) for Sigmoid constraint with respect to xᵢ on a hyperspherical manifold according to the present disclosure is composed of both intra-class loss and inter-class loss, i.e., L_{SFace}=Lᵢₙₜᵣₐ(θ_{y}_{ᵢ})+Lᵢₙₜₑᵣ(θⱼ).

In particular, the intra-class loss Lᵢₙₜᵣₐ(θ_{y}_{ᵢ}) and the inter-class loss Lᵢₙₜₑᵣ(θⱼ) are defined as:

Lᵢₙₜᵣₐ(θ_{y}_{ᵢ})=−[rᵢₙₜᵣₐ(θ_{y}_{ᵢ})]_{b} cos(θ_{y}_{ᵢ}), (2)

Lᵢₙₜₑᵣ(θⱼ)=Σ_{j=1,j≠y}_{ᵢ}^{C}[rᵢₙₜₑᵣ(j)]_{b} cos(θⱼ), (3)

Among them, θ_{y}_{ᵢ} is the intra-class angular distance between xᵢ/∥xᵢⱼ∥ and W_{y}_{ᵢ}/∥W_{y}_{ᵢ}∥ and θⱼ(j≠yᵢ) is the inter-class angular distance between xᵢ/∥xᵢ∥ and W_{y}_{ᵢ}/∥W_{y}_{ᵢ}∥. Among them, cos(θ_{y}_{ᵢ})=W_{y}_{ᵢ}^{T}xᵢ/∥W_{y}_{ᵢ}∥∥xᵢ∥, cos(θⱼ)=Wⱼ^{T}xᵢ/∥Wⱼ∥∥xᵢ∥, j≠yᵢ, [ . . . ]_{b} indicates the gradient scalar calculated by the weight function, which weights the intra-class cosine angular distance loss and inter-class cosine angular distance loss during the training process, and whose constant value is calculated for weighting in each iteration.

In a forward propagation process, the current loss is calculated according to the new loss function SFace, whose formula is as follows:

L_{SFace}=−[rᵢₙₜᵣₐ(θ_{y}_{ᵢ})]_{b} cos(θyᵢ)+Σ_{j=1,j≠y}_{ᵢ}^{C}[rᵢₙₜₑᵣ(θⱼ)]_{b} cos(θⱼ) (4)

In the back propagation process for updating, according to the principle of the back propagation algorithm, the partial derivative function used for parameter updating is also weighted by the block gradient operator, as follows:

$$\begin{matrix}\frac{\partial {L}_{SFace}}{\partial {x}_{i}} = - {[ {r}_{intra} ( {θ}_{{y}_{i}} ) ]}_{b} \frac{\partial cos ( {θ}_{{y}_{i}} )}{\partial {x}_{i}} + {\sum }_{j = 1 , j \neq {y}_{i}}^{C} {[ {r}_{inter} ( {θ}_{j} ) ]}_{b} \frac{\partial cos ( {θ}_{j} )}{\partial {x}_{i}} , & ( 5 ) \\ \frac{\partial {L}_{SFace}}{\partial {W}_{{y}_{i}}} = - {[ {r}_{intra} ( {θ}_{{y}_{i}} ) ]}_{b} \frac{\partial cos ( {θ}_{{y}_{i}} )}{\partial {W}_{{y}_{i}}} , & ( 6 ) \\ \frac{\partial {L}_{SFace}}{\partial {W}_{j}} = {[ {r}_{intra} ( {θ}_{j} ) ]}_{b} \frac{\partial cos ( {θ}_{j} )}{\partial {W}_{j}} , & ( 7 )\end{matrix}$$

Among them,

$$\begin{matrix}\frac{\partial cos ( {θ}_{{y}_{i}} )}{\partial {x}_{i}} = \frac{1}{‖ {x}_{i} ‖} ( \frac{{W}_{{y}_{i}}}{‖ {W}_{{y}_{i}} ‖} - cos ( {θ}_{{y}_{i}} ) \frac{{x}_{i}}{‖ {x}_{i} ‖} ) , & ( 8 ) \\ \frac{\partial cos ( {θ}_{j} )}{\partial {x}_{i}} = \frac{1}{‖ {x}_{i} ‖} ( \frac{{W}_{j}}{‖ {W}_{j} ‖} - cos ( {θ}_{j} ) \frac{{x}_{i}}{‖ {x}_{i} ‖} ) , & ( 9 ) \\ \frac{\partial cos ( {θ}_{{y}_{i}} )}{\partial {W}_{i}} = \frac{1}{‖ {W}_{{y}_{i}} ‖} ( \frac{{x}_{i}}{‖ {W}_{i} ‖} - cos ( {θ}_{{y}_{i}} ) \frac{{W}_{{y}_{i}}}{‖ {W}_{{y}_{i}} ‖} ) , & ( 10 ) \\ \frac{\partial cos ( {θ}_{j} )}{\partial {W}_{j}} = \frac{1}{‖ {W}_{j} ‖} ( \frac{{x}_{i}}{‖ {x}_{i} ‖} - cos ( {θ}_{j} ) \frac{{x}_{j}}{‖ {W}_{j} ‖} ) . & ( 11 )\end{matrix}$$

Wherein, the above formulas (5) to (7) may correspond to the updating functions according to the present disclosure.

The above formulas (8) to (11) can be directly obtained through mathematical derivation operations. The derivation of formula (8) will be described in detail below, and it should be understood that other formulas can be calculated through similar mathematical derivations.

For

$$\frac{\partial cos ( {θ}_{{y}_{i}} )}{\partial {x}_{i}} = \frac{1}{‖ {x}_{i} ‖} ( \frac{{W}_{{y}_{i}}}{‖ {W}_{{y}_{i}} ‖} - cos ( {θ}_{{y}_{i}} ) \frac{{x}_{i}}{‖ {x}_{i} ‖} ) ,$$

where xᵢ={xᵢ¹,xᵢ², . . . , xᵢ^{k}, . . . , xᵢ^{d}}∈ [symbol] ^{d}, W_{y}_{ᵢ}={W_{y}_{ᵢ}¹,W_{y}_{ᵢ}², . . . , W_{y}_{ᵢ}^{k}, . . . , W_{y}_{ᵢ}^{d}}∈ [symbol] ^{d}, 1≤k≤d, the derivation is as follows:

First of all:

$$cos ( {θ}_{{y}_{i}} ) - {W}_{{y}_{i}}^{T} {x}_{i} / ‖ {W}_{{y}_{i}} ‖ ‖ {x}_{i} ‖ = \frac{{\sum }_{k = 1}^{d} {W}_{{y}_{i}}^{k} {x}_{i}^{j}}{\sqrt{{\sum }_{k = 1}^{d} {( {W}_{{y}_{i}}^{k} )}^{2}} \sqrt{{\sum }_{k = 1}^{d} {( {x}_{i}^{k} )}^{2}}} \qquad ( 12 )$$

Its partial derivative is:

$$\begin{matrix}\frac{\partial cos {θ}_{{y}_{i}}}{\partial {x}_{i}} = \frac{\begin{matrix}{W}_{{y}_{i}}^{k} \sqrt{{\sum }_{k = 1}^{d} {( {W}_{{y}_{i}}^{k} )}^{2}} \sqrt{{\sum }_{k = 1}^{d} {( {x}_{i}^{k} )}^{2}} - \\ {\sum }_{k = 1}^{d} {W}_{{y}_{i}}^{k} {x}_{i}^{k} \frac{2 {x}_{i}^{k} \sqrt{{\sum }_{k = 1}^{d} {( {W}_{{y}_{i}}^{k} )}^{2}}}{2 \sqrt{{\sum }_{k = 1}^{d} {( {x}_{i}^{k} )}^{2}}}\end{matrix}}{{\sum }_{k = 1}^{d} {( {W}_{{y}_{i}}^{k} )}^{2} {\sum }_{k = 1}^{d} {( {x}_{i}^{k} )}^{2}} \\ = \frac{1}{\sqrt{{\sum }_{k = 1}^{d} {( {x}_{i}^{k} )}^{2}}} \\ ( \begin{matrix}\frac{{W}_{{y}_{i}}^{k}}{\sqrt{{\sum }_{k = 1}^{d} {( {W}_{{y}_{i}}^{k} )}^{2}}} - \frac{{\sum }_{k = 1}^{d} {W}_{{y}_{i}}^{k} {x}_{i}^{k}}{\sqrt{{\sum }_{k = 1}^{d} {( {W}_{{y}_{i}}^{k} )}^{2}} \sqrt{{\sum }_{k = 1}^{d} {( {x}_{i}^{k} )}^{2}}} \\ \frac{{x}_{i}^{k}}{\sqrt{{\sum }_{k = 1}^{d} {( {x}_{i}^{k} )}^{2}}}\end{matrix} ) \\ = \frac{1}{\sqrt{{\sum }_{k = 1}^{d} {( {x}_{i}^{k} )}^{2}}} ( \begin{matrix}\frac{{W}_{{y}_{i}}^{k}}{\sqrt{{\sum }_{k = 1}^{d} {( {W}_{{y}_{i}}^{k} )}^{2}}} - \\ cos ( {θ}_{{y}_{i}} ) \frac{{x}_{i}^{k}}{\sqrt{{\sum }_{k = 1}^{d} {( {x}_{i}^{k} )}^{2}}}\end{matrix} )\end{matrix} \qquad ( 13 )$$

Therefore it can conclude that:

$$\frac{\partial cos ( {θ}_{{y}_{i}} )}{\partial {x}_{i}} = \frac{1}{‖ {x}_{i} ‖} ( \frac{{W}_{{y}_{i}}}{‖ {W}_{{y}_{i}} ‖} - cos ( {θ}_{{y}_{i}} ) \frac{{x}_{i}}{‖ {x}_{i} ‖} ) \qquad ( 14 )$$

Because, as shown in FIG. 5C,

$$〈 \frac{\partial cos ( {θ}_{{y}_{i}} )}{\partial {x}_{i}} , {x}_{i} 〉 = 0 , 〈 \frac{\partial cos ( {θ}_{j} )}{\partial {x}_{i}} , {x}_{i} 〉 = 0 , 〈 \frac{\partial cos ( {θ}_{{y}_{i}} )}{\partial {W}_{i}} , {W}_{{y}_{i}} 〉 = 0 , \\ 〈 \frac{\partial cos ( {θ}_{j} )}{\partial {W}_{j}} , {W}_{j} 〉 = 0 ,$$

the optimal gradient direction always follows the
tangent direction of the hypersphere. Since the gradient has no component in the radial direction, ∥xᵢ∥, ∥W_{y}_{ᵢ}∥ and ∥Wⱼ∥ keep almost unchanged during the training process, so [rᵢₙₜᵣₐ(θ_{y}_{ᵢ})]_{b} and [rᵢₙₜₑᵣ(θⱼ)]_{b} are further designed as scalar functions of θ_{y}_{ᵢ} and θⱼ respectively, so as to readjust the optimization target.

As shown in FIG. 3A, there are actually two factors which can re-adjust the gradient, that is, control the moving speed of the training samples and the target center. Therefore, [rᵢₙₜᵣₐ(θ_{y}_{ᵢ})]_{b} and [rᵢₙₜₑᵣ(θⱼ)]_{b} can be set as gradient re-adjustment functions which are determined based on the weight function. Because initial gradient magnitudes of the intra-class loss and inter-class loss are proportional to sin θ_{y}_{ᵢ} and sin θⱼ respectively, the final gradient magnitudes are proportional to vᵢₙₜᵣₐ(θ_{y}_{ᵢ})=rᵢₙₜᵣₐ(θ_{y}_{ᵢ})sin θ_{y}_{ᵢ} and vᵢₙₜₑᵣ(θⱼ)=rᵢₙₜₑᵣ(θⱼ)sin θⱼ respectively.

As well known, when starting the training, each of the initial intra-class angular distance θ_{y}_{ᵢ} and inter-class angular distance ∴ⱼ are about

$$\frac{π}{2} .$$

As the training progresses, the intra-class loss function gradually reduces the intra-class angle θ_{y}_{ᵢ}, while the inter-class loss function prevents the inter-class angle θⱼ from decreasing. Therefore, the function vᵢₙₜᵣₐ(θ_{y}_{ᵢ}) and vᵢₙₜₑᵣ(θⱼ) for gradient magnitude control according to the present disclosure can satisfy the following properties:
(1) The function vᵢₙₜᵣₐ(θ_{y}_{ᵢ}) should be a function which is non-negative and monotonically increases within an interval

$$[ 0 , \frac{π}{2} ]$$

so that it can be ensured that as xᵢ and W_{y}_{ᵢ} approaches with each other, their moving speed gradually decreases.
(2) The function vᵢₙₜₑᵣ(θⱼ) should be a function which is non-negative and monotonically decreases within the interval

$$[ 0 , \frac{π}{2} ] ,$$

so that it can be ensured that if xᵢ and W_{y}_{ᵢ} approaches with each other, the weights will enlarge quickly.
(3) Considering the existence of noise in the training data, the function vᵢₙₜᵣₐ(θ_{y}_{ᵢ}) should be designed with a flexible cut-off point near the intra-class angle of 0 to limit the convergence speed of the intra-class loss; the function vᵢₙₜₑᵣ(θⱼ) should be designed with a flexible cut-off point near the inter-class angle of

$$\frac{π}{2}$$

to control the convergence speed of the inter-class loss. In this way, the intra-class and inter-class optimization targets can be moderately adjusted, instead of being strictly maximized or minimized.

In order to flexibly control the moving speed of the gradient to fit with the training data containing noise, weight functions rᵢₙₜᵣₐ(θ_{y}_{ᵢ}) and rᵢₙₜₑᵣ(θⱼ) based on Sigmoid are proposed, and their specific formulas are as follows:

$$\begin{matrix}{r}_{intra} ( {θ}_{{y}_{i}} ) = \frac{S}{1 + {e}^{- a * ( {θ}_{{y}_{i}} - b )}} , & ( 15 ) \\ {r}_{inter} ( {θ}_{j} ) = \frac{S}{1 + {e}^{c * ( {θ}_{j} - d )}} . & ( 16 )\end{matrix}$$

Among them, S is an initial scale parameter that controls the gradients of two Sigmoid-type curves; a and b are parameters that control the slope and horizontal intercept of the Sigmoid-type curve of [vᵢₙₜᵣₐ(θ_{y}_{ᵢ})]_{b}; c and d are parameters that control the slope and horizontal intercept of the Sigmoid-type curve of [vᵢₙₜₑᵣ(θⱼ)]_{b}, and these parameters actually control a flexible interval to suppress the moving speed of gradient.

Further, it is to be noted that the above formulas (15) and (16) may be replaced by the following formulas:

$$\begin{matrix}{r}_{intra} ( {θ}_{{y}_{i}} ) = \frac{S}{1 + {e}^{- a * ( {θ}_{{y}_{i}} - b )}} , \\ {r}_{inter} ( {θ}_{j} ) = \frac{S}{1 + {e}^{c * ( {θ}_{j} - d )}} .\end{matrix}$$

wherein k means a parameter that controls the slope of the Sigmoid-type curve of such weight functions, and a and b mean parameters that control the horizontal intercepts of the Sigmoid-type curve of respective weight functions. The number of parameters included in the above formulas are small compared to that of the formulas (15) and (16), which means that easier handing can be ensured in case of these formulas.

The weight functions rᵢₙₜᵣₐ(θ_{y}_{ᵢ}) and rᵢₙₜₑᵣ(θⱼ) for the Sigmoid type curves change with its parameters, as shown in FIG. 5D. Further, the theoretical magnitudes of the intra-class gradient readjustment function and the inter-class gradient readjustment function are vᵢₙₜᵣₐ(θ_{y}_{ᵢ})=rᵢₙₜᵣₐ(θ_{y}_{ᵢ})sin θ_{y}_{ᵢ} and vᵢₙₜₑᵣ(θⱼ)=rᵢₙₜₑᵣ(θⱼ)sin θⱼ, and by means of such functions, appropriate adjustment curves for the intra-class gradient and the inter-class gradient can be obtained, as shown in FIG. 5E. which illustrates final adjustment curves for the intra-class gradient and the inter-class gradient according to the method of the present disclosure.

The weight function according to the present disclosure is used for controlling the intra-class loss and the extra-class loss, so as to control the gradient convergence speed to be suitable for different training sets. Preferably, the weight function for the intra-class angle should decrease smoothly and monotonically as the intra-class angle decreases, and the hyperparameters of the weight function can be adjusted to make the magnitude of the gradient to be more suitable for the training data set. The weight function for the inter-class angle should decrease smoothly and monotonically as the inter-class angle becomes larger, and the hyperparameters of the weight function can be adjusted to make the magnitude of the gradient to be more suitable for the training data set.

The differences between the model training method according to the present disclosure and the existing Softmax-based training method will be described below.

In addition to the original Softmax function described above, in order to further improve the accuracy, the idea of large boundaries is introduced into cos(θ_{y}_{ᵢ}) currently. In this way, the Softmax-based loss function can be defined as:

$$L = - \frac{1}{N} {\sum }_{i}^{N} log {P}_{{y}_{i}} = - \frac{1}{N} {\sum }_{i}^{N} log \frac{{e}^{sf ( {θ}_{{y}_{i}} )}}{{e}^{sf ( {θ}_{{y}_{i}} )} + {\sum }_{j = 1 , j \neq {y}_{i}}^{C} {e}^{scos {θ}_{j}}} \qquad ( 17 )$$

Among them, in a NSoftmax method, f(θ_{y}_{ᵢ})=cos θ_{y}_{ᵢ}, in a CosFace method, f(θ_{y}_{ᵢ})=cos θ_{y}_{ᵢ}−m, and in an ArcFace method, f(θ_{y}_{ᵢ})=cos(θ_{y}_{ᵢ}+m). It can be theoretically seen that θ_{y}_{ᵢ} will decrease with the loss function and θⱼ will increase with the optimization of the loss function. In the process of backpropagation, their partial derivative formulas are as follows:

$$\begin{matrix}\frac{\partial L}{\partial cos {θ}_{{y}_{i}}} = s ( {P}_{{y}_{i}} - 1 ) \frac{\partial f ( {θ}_{{y}_{i}} )}{\partial cos {θ}_{{y}_{i}}} = \frac{s {\sum }_{j = 1 , j \neq {y}_{i}}^{C} {e}^{scos {θ}_{j}}}{{e}^{sf ( {θ}_{{y}_{i}} )} + {\sum }_{j = 1 , j \neq {y}_{i}}^{C} {e}^{scos {θ}_{j}}} \frac{\partial f ( {θ}_{{y}_{i}} )}{\partial cos {θ}_{{y}_{i}}} & ( 18 ) \\ \frac{\partial L}{\partial cos {θ}_{j}} = {sP}_{j} = \frac{{se}^{scos {θ}_{j}}}{{e}^{sf ( {θ}_{{y}_{i}} )} + {\sum }_{k = 1 , k \neq {y}_{i}}^{C} {e}^{scos {θ}_{k}}} & ( 19 )\end{matrix}$$

Among them, in the NSoftmax method and the CosFace method,

$$\frac{\partial f ( {θ}_{{y}_{i}} )}{\partial cos {θ}_{{y}_{i}}} = 1 ,$$

and in the ArcFace method.

$$\frac{\partial f ( {θ}_{{y}_{i}} )}{\partial cos {θ}_{{y}_{i}}} = \frac{sin ( {θ}_{{y}_{i}} + m )}{sin {θ}_{{y}_{i}}} .$$

It should be noted that the above partial derivative formulas (18) and (19) are derived only for comparison with the technical solution of the present disclosure, and their derivation process is as follows. However, in the current implementation, such formula transformation is not necessarily performed.

The derivation of formula (18) is as follows:

First, according to a chain derivation rule, we can get:

$$\frac{\partial L}{\partial cos {θ}_{{y}_{i}}} = \frac{\partial L}{\partial ( {θ}_{{y}_{i}} )} \frac{\partial f ( {θ}_{{y}_{i}} )}{\partial cos {θ}_{{y}_{i}}} \qquad ( 20 )$$

Among them:

$$\begin{matrix}\frac{\partial L}{\partial ( {θ}_{{y}_{i}} )} = - \frac{{e}^{sf ( {θ}_{{y}_{i}} )} + {\sum }_{j = 1 , j \neq {y}_{i}}^{C} {e}^{scos {θ}_{j}}}{{e}^{sf ( {θ}_{{y}_{i}} )}} \cdot \frac{{se}^{sf ( {θ}_{{y}_{i}} )} ( {e}^{sf ( {θ}_{{y}_{i}} )} + {\sum }_{j = 1 , j \neq {y}_{i}}^{C} {e}^{scos {θ}_{j}} ) - {s ( {e}^{sf ( {θ}_{{y}_{i}} )} )}^{2}}{{( {e}^{sf ( {θ}_{{y}_{i}} )} + {\sum }_{j = 1 , j \neq {y}_{i}}^{C} {e}^{scos {θ}_{j}} )}^{2}} & ( 21 ) \\ \frac{\partial L}{\partial ( {θ}_{{y}_{i}} )} = \frac{s {\sum }_{j = 1 , j \neq {y}_{i}}^{C} {e}^{scos {θ}_{j}}}{{e}^{sf ( {θ}_{{y}_{i}} )} + {\sum }_{j = 1 , j \neq {y}_{i}}^{C} {e}^{socs {θ}_{j}}} & ( 22 )\end{matrix}$$

So it can be get:

$$\frac{\partial L}{\partial cos {θ}_{{y}_{i}}} = \frac{{se}^{sf ( {θ}_{{y}_{i}} )}}{{e}^{sf ( {θ}_{{y}_{i}} )} + {\sum }_{j = 1 , j \neq {y}_{i}}^{C} {e}^{scos {θ}_{j}}} \frac{\partial f ( {θ}_{{y}_{i}} )}{\partial cos {θ}_{{y}_{i}}} \qquad ( 23 )$$

The derivation of formula (19) is as follows:

$$\frac{\partial L}{\partial cos {θ}_{j}} = - \frac{{e}^{sf ( {θ}_{{y}_{i}} )} + {\sum }_{k = 1 , k \neq {y}_{i}}^{C} {e}^{scos {θ}_{k}}}{{e}^{sf ( {θ}_{{y}_{i}} )}} \cdot \frac{{se}^{sf ( {θ}_{{y}_{i}} )} {e}^{scos {θ}_{j}}}{{( {e}^{sf ( {θ}_{{y}_{i}} )} + {\sum }_{k = 1 , k \neq {y}_{i}}^{C} {e}^{scos {θ}_{k}} )}^{2}} \\ 1. = \frac{{se}^{scos {θ}_{j}}}{{e}^{sf ( {θ}_{{y}_{i}} )} + {\sum }_{k = 1 , k \neq {y}_{i}}^{C} {e}^{scos {θ}_{k}}} \qquad ( 24 )$$

Further, a softmax-based loss function is equivalent to the following formula:

L=−[rᵢₙₜᵣₐ(θ_{y}_{ᵢ},θⱼ)]_{b} cos(θ_{y}_{ᵢ})+Σ_{j=1,j≠y}_{ᵢ}^{C}[rᵢₙₜₑᵣ(θ_{y}_{ᵢ},θⱼ)]_{b} cos(θⱼ) (25)

Among them,

$${r}_{intra} ( {θ}_{{y}_{i}} , {θ}_{j} ) = \frac{s {\sum }_{j = 1 , j \neq {y}_{i}}^{C} {e}^{scos {θ}_{j}}}{{e}^{sf ( {θ}_{{y}_{i}} )} + {\sum }_{j = 1 , j \neq {y}_{i}}^{C} {e}^{scos {θ}_{j}}} \frac{\partial f ( {θ}_{{y}_{i}} )}{\partial cos {θ}_{{y}_{i}}} , \\ {r}_{inter} ( {θ}_{{y}_{i}} , {θ}_{j} ) = \frac{{se}^{scos {θ}_{j}}}{{e}^{sf ( {θ}_{{y}_{i}} )} + {\sum }_{k = 1 , k \neq {y}_{i}}^{C} {e}^{scos {θ}_{k}}} .$$

It should be noted that the above formula (25) is derived only for comparison with the technical solution of the present disclosure, but in the current implementation, the loss function is not necessarily derived as formula (25).

Moreover, because the parameters of the deep neural network are only updated in the back-propagation stage during the entire training process, and the back-propagation functions for formula (17) and formula (25) are the same, that is,

$$\begin{matrix}\frac{\partial L}{\partial cos {θ}_{{y}_{i}}} = \frac{{se}^{sf ( {θ}_{{y}_{i}} )}}{{e}^{sf ( {θ}_{{y}_{i}} )} + {\sum }_{j = 1 , j \neq {y}_{i}}^{C} {e}^{scos {θ}_{j}}} \frac{\partial f ( {θ}_{{y}_{i}} )}{\partial cos {θ}_{{y}_{i}}} & ( 26 ) \\ \frac{\partial L}{\partial cos {θ}_{j}} = \frac{{se}^{scos {θ}_{j}}}{{e}^{sf ( {θ}_{{y}_{i}} )} + {\sum }_{j = 1 , j \neq {y}_{i}}^{C} {e}^{scos {θ}_{k}}} & ( 27 )\end{matrix}$$

Therefore, in the model training stage, formula (17) and formula (25) are equivalent to each other.

From the loss functions rewritten above, it can be seen that the Softmax-based loss function can be considered as a metric learning method with a specific optimization speed constraint on the sphere. According to the experimental analysis for the existing methods, most of θⱼ have been maintained in the vicinity of

$$\frac{π}{2}$$

with slight change during the actual training, so it can assume that

$$cos {θ}_{j} \approx cos \frac{π}{2} = 0 ,$$

and the following inferences are obtained:

$$\begin{matrix}{r}_{intra} ( {θ}_{{y}_{i}} ) \approx \frac{{se}^{sf ( {θ}_{{y}_{i}} )}}{{e}^{sf ( {θ}_{{y}_{i}} )} + C} \frac{\partial f ( {θ}_{{y}_{i}} )}{\partial cos {θ}_{{y}_{i}}} & ( 28 ) \\ {r}_{inter} ( {θ}_{j} ) \approx \frac{{se}^{scos {θ}_{j}}}{{e}^{sf ( {θ}_{{y}_{i}} )} + C} & ( 29 )\end{matrix}$$

For more intuitive comparison, the curves corresponding to the intra-class gradient adjustment function vᵢₙₜᵣₐ(θ_{y}_{ᵢ})=rᵢₙₜᵣₐ(θ_{y}_{ᵢ})sin θ_{y}_{ᵢ} and inter-class gradient adjustment function vᵢₙₜₑᵣ(θⱼ)=rᵢₙₜₑᵣ(θⱼ)sin θⱼ of NSoftmax, CosFace and ArcFace methods are shown in FIG. 5F, where (1) illustrates the curves of intra-class gradient vᵢₙₜᵣₐ(θ_{y}_{ᵢ}) and inter-class gradient vᵢₙₜₑᵣ(θⱼ) of NSoftmax method, (2) illustrates the curves of intra-class gradient vᵢₙₜᵣₐ(θ_{y}_{ᵢ}) and inter-class gradient vᵢₙₜₑᵣ(θⱼ) of the CosFace method, and (3) illustrates the curves of intra-class gradient vᵢₙₜᵣₐ(θ_{y}_{ᵢ}) and inter-class gradient vᵢₙₜₑᵣ(θⱼ) of the ArcFace method. Where θ_{y}_{ᵢ} is set as

$$\frac{π}{4}$$

in the curves of the inter-class gradient adjustment functions. But in practice, this assumption is not always true, because θⱼ actually fluctuates near

$$\frac{π}{2}$$

but θ_{y}_{ᵢ} gradually decreases.

From the comparison between FIGS. 5E and 5F, it is clear that the softmax-based loss functions cannot accurately control the intra-class and inter-class optimization processes. In particular, the gradient curves corresponding to the loss functions in the prior art are almost a set of curves with the same shape, that is, their gradient magnitude change following the similar rules, so the change of the gradient magnitude is basically fixed during the model training/optimization process, so that overfitting cannot be effectively avoided; on the contrary, the loss function according to the present disclosure can precisely control the optimization process. In particular, by precisely controlling the change rule of the gradient magnitude of the gradient curve by using parameters so as to adapt to different training data sets, the overfitting can be effectively reduced or even avoided.

According to the present disclosure, the apparatus may further include an image feature acquisition unit configured to acquire image features from a training image set using the neural network model. The acquisition of image features can be performed in a manner known in the art, which will not be described in detail here. Of course, the image feature acquisition unit may be located outside the apparatus according to the present disclosure.

It should be noted that FIG. 4A only illustrates a overview diagram of structural configuration of the training apparatus, and the training apparatus may further include other possible units/components (for example, a storage, etc.). The storage may store various information (for example, image features of the training set, loss data, function parameter values, etc.) generated by the training apparatus, programs and data used for operation of the training apparatus, and the like. For example, the storage may include, but is not limited to, random access memory (RAM), dynamic random access memory (DRAM), static random access memory (SRAM), read-only memory (ROM), and flash memory, etc. As an example, the storage may also be located outside the training apparatus. The training apparatus may be directly or indirectly (for example, other components may be interposed therebetween) connected to the storage for data access. The storage may be a volatile storage and/or a non-volatile storage.

It should be noted that the above units can be logical modules divided according to specific functions they implement, and are not used to limit specific implementations, for example, they can be implemented in software, hardware, or a combination of software and hardware. In actual implementation, the foregoing units may be implemented as independent physical entities, or may be implemented by a single entity (for example, a processor (CPU or DSP, etc.), an integrated circuit, etc.). In addition, the above-mentioned individual units are shown by dashed lines in the figure to indicate that these units may not actually exist, and the operations/functions they implement may be realized by the processing circuitry itself.

It should be noted that in addition to including a plurality of units, the above-mentioned training apparatus may be implemented in various other forms, such as a general-purpose processor or a dedicated processing circuit such as an ASIC. For example, the training apparatus can be configured by a circuit (hardware) or a central processing device such as a central processing unit (CPU). In addition, the training apparatus may carry a program (software) for operating a circuit (hardware) or a central processing device. The program can be stored in a storage (such as arranged in the storage) or an external storage medium connected from the outside, and downloaded via a network (such as the Internet).

According to an embodiment of the present disclosure, a method for training a neural network model for object recognition is proposed, as shown in FIG. 4B, the method 500 comprises a loss determination step 502 of determining loss data for features extracted from a training image set using the neural network model and a loss function with a weight function, and an update step 504 of performing an updating operation for parameters of the neural network model based on the loss data and an updating function, wherein the updating function is derived based on the loss function of the neural network model with the weight function, and the weight function and the loss function change monotonically in a specific value interval in the same direction.

According to the present disclosure, the method may further include an image feature acquisition step of acquiring image features from a training image set using the neural network model. The acquisition of image features can be performed in a manner known in the art, which will not be described in detail here. Of course, the image feature acquisition step may not be included in the method according to the present disclosure.

It should be noted that the method according to the present disclosure may also include various operations described above, which will not be described in detail here. It should be noted that respective steps/operations of the method according to the present disclosure can be performed by the above-mentioned units, and may also be performed by various forms of processing circuits.

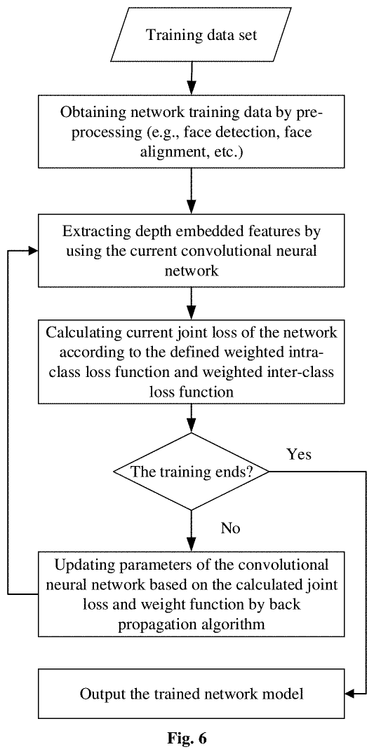

A model training operation according to the present disclosure will be described below with reference to FIG. 6. FIG. 6 illustrates a basic flowchart of a model training operation according to the present disclosure.

First, a training data set is input, and the training data set may include a large number of object images, such as face images, for example, tens of thousands, hundreds of thousands, millions of object images.

Then, the images in the input training data set may be pre-processed, and the pre-processing operations may include, for example, object detection, object alignment, and the like. Taking face recognition as an example, the pre-processing may include face detection, such as detecting a face from an image containing the face and obtaining an image mainly containing the face to be recognized. Face alignment belongs to a kind of normalization operation for face recognition. The main purpose of face alignment is to eliminate unwanted intra-class changes by aligning the image towards some standardized shapes or structures. It should be noted that the pre-processing operation may also include other types of pre-processing operations known in the art, which will not be described in detail here.

Then, the pre-processed images in the training set are input into a convolutional neural network model for feature extraction. The convolutional neural network model may adopt various structures known in the art, which will not be described in detail here.

Then, the loss is calculated by a loss function. The loss function may be a function known in the art, or a loss function based on a weight function proposed according to the present disclosure.

Then, the parameters of the convolutional neural network are updated by back propagation based on the calculated loss data. It should be noted that the updating function defined in accordance with the present disclosure can be used in the back propagation to update the parameters of the convolutional neural network model. The updating function is defined as described above, and will not be described in detail here.

Existing unconstrained learning methods drag the noise samples strictly onto wrong labels, thereby making the noise samples overfit. However, the model training according to the present disclosure alleviates this problem to some extent, because it optimizes the noise samples in a gentle way.

According to an embodiment of the present disclosure, by using an improved weight function for dynamically controlling the amplitude of model updating/optimization, that is, the gradient descent speed, during the training process, it is possible to further optimize the training of a model for object recoginition, such as a convolutional neural network model, compared with the prior art, so that a more optimized object recognition model can be obtained, and in turn the accuracy of object recognition/authentication is further improved.

In addition, in the embodiments of the present disclosure, instead of the cross-entropy loss, the intra-class angle and inter-class angle are directly optimized as the target of the loss function, which are consistent with the prediction process targets, thereby simplifying the intermediate process in the training process, reducing calculation overhead and improving optimization accuracy.

Moreover, in the embodiments of the present disclosure, the loss function takes into account intra-class loss and inter-class loss individually, which decouples the intra-class gradient term and the inter-class gradient term, helps to analyze the lossess of the intra-class gradient term and the inter-class gradient term, and guides the optimization of the intra-class gradient term and the inter-class gradient term individually. In particular, appropriate weighting functions are used for the intra-class loss and inter-class loss respectively to control the gradient convergence speed, so as to prevent overfitting of the noisy training samples, so that even for a training set containing noise, an optimized training model can still be obtained.

Hereinafter, the effects of the model training methods according to the present disclosure and that in the prior art will be compared by experiments.

### Experiment 1: Verification on a Small Training Set

Training set: CASIA-WebFace, including 10,000 personal identities, a total of 500,000 images.

Test sets: YTF, LFW, CFP-FP, AGEDB-30, CPLFW, CALFW

Evaluation criteria: 1: N TPIR (True Positive Recognition Rate, Rank1 @ 10⁶), the same as Megafacechallenge

Convolutional neural network architecture: RestNet50

prior art technologies to be compared: Softmax, NSoftmax, SphereFace, CosFace, ArcFace, D-Softmax

The experimental results are shown in Table 1 below, where SFace is a technical solution according to the present disclosure.

TABLE 1
Comparison between the result of the training operation of the present
isclosure with the results of the prior art technologies

| algorithms | YTF | LFW | CFP-FP | AGEDB | CPLFW | CALFW |
|---|---|---|---|---|---|---|
| softmax | 95.60% | 99.25% | 95.10% | 93.28% | 88.97% | 92.48% |
| Nsoftmax | 95.54% | 99.23% | 95.00% | 93.17% | 88.82% | 92.40% |
| SphereFace | 93.18% | 99.17% | 94.76% | 92.60% | 86.50% | 91.93% |
| (m = 1.35, s = 64) | | | | | | |
| CosFace | 95.76% | 99.53% | 95.50% | 95.23% | 90.32% | 93.97% |
| (m = 0.35, s = 64) | | | | | | |
| ArcFace | 95.66% | 99.52% | 95.60% | 95.30% | 89.97% | 93.77% |
| (m = 0.5, s = 64) | | | | | | |
| D-softmax | 95.42% | 99.50% | 95.44% | 93.95% | 89.60% | 92.95% |
| (d = 0.9, s = 32) | | | | | | |
| SFace | 95.82% | 99.50% | 95.81% | 95.10% | 90.18% | 94.07% |
| (a = 80.00, b = 0.87, | | | | | | |
| c = 80.00, d = 1.20) | | | | | | |

### Experiment 2: Validation on a Large Training Set

Training set: MS1MV2, including 85,000 person identities, a total of 5,800,000 images.

Evaluation set: LFW, YTF, CPLFW, CALFW, IJB-C

Evaluation criteria: 1: N TPIR (True Positive Identification Rate, Rank1 @106) and TPR/FPR

Convolutional neural network architecture: RestNet100

Prior art technology to be compared: ArcFace

The experimental results are shown in Tables 2 and 3 below, where SFace is the technical solution according to the present disclosure.

TABLE 2
Comparison between the result of the training operation of the
present disclosure and the results of the prior art technology

| algorithm | LFW | YTF | CPLFW | CALFW |
|---|---|---|---|---|
| ArcFace (m = 0.5, s = 64) | 99.83% | 98.02% | 92.08% | 95.45% |
| SFace (a = 80.00, b = 0.90, | 99.82% | 98.06% | 93.28% | 96.07% |
| c = 80.00, d = 0.20) | | | | |

TABLE 3
Comparison between the result of the training operation of the
present disclosure and the results of the prior art technology

| | IJB-C dataset | | | | | |
|---|---|---|---|---|---|---|
| | TPR/FPR | | | | | |
| algorithm | 10⁻⁶ | 10⁻⁵ | 10⁻⁴ | 10⁻³ | 10⁻² | 10⁻¹ |
| ArcFace | 86.25% | 93.15% | 95.65% | 97.20% | 98.18% | 99.01% |
| SFace | 89.40% | 94.21% | 96.11% | 97.50% | 98.33% | 99.00% |
| (a = 80.00, | | | | | | |
| b = 0.90, | | | | | | |
| c = 80.00, | | | | | | |
| d = 0.20) | | | | | | |

Experimental results show that the model training solution according to the present disclosure has better performance than the prior art.

Hereinafter, exemplary implementations according to the present disclosure will be described in detail with reference to the accompanying drawings. It should be noted that the following description is mainly intended to clearly explain the training process according to the present disclosure, but some steps or operations thereof are not necessary, for example, the pre-processing step and the feature extraction step are not necessary, and the operation according to the present disclosure can be performed directly based on the received features.

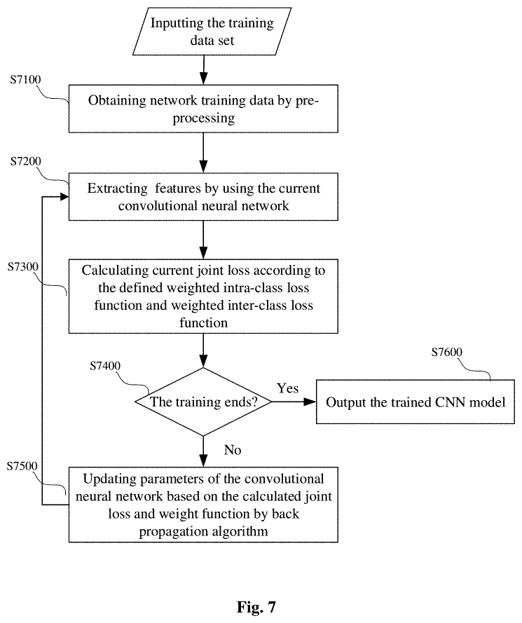

FIG. 7 illustrates a flowchart of training a convolutional neural network model by using a joint loss function proposed by the present disclosure according to a first embodiment of the present disclosure. The model training process according to the first embodiment of the present disclosure includes the following steps.

S7100: Obtain network training data through pre-processing

In this step, the input are original images with the real mark of an object or face, and then the input original images are converted into training data that meets the requirements of the convolutional neural network through a series of pre-processing operations. This series of pre-processing operations include face or object detection, face or object alignment, image augmentation, image normalization, and so on.

S7200: Use a current convolutional neural network to extract features

In this step, the input are image data with an object or a face that has met the requirements of the convolutional neural network, and then a selected convolutional neural network structure and current corresponding parameters are utilized to extract image features. The convolutional neural network structure can be a common network structure, such as VGG16, ResNet, SENet, and so on.

S7300: Calculate the current joint loss based on the proposed weighted intra-class loss function and weighted inter-class loss function

In this step, the input are the extracted image features and the last fully connected layer of the convolutional neural network, and then the current intra-class loss and inter-class loss are calculated based on the proposed joint weighted loss function, respectively. Specific loss function definitions can be seen with reference to formulas (2) to (4) as described above.

S7400: Judge whether to end the training process

In this step, it can be judged whether to end the training based on some pre-set conditions. The preset conditions may include a loss threshold condition, an iteration number condition, a gradient descent speed condition, and the like. If at least one of the conditions is met, the training can end and the process proceeds to S7600. If all the preset conditions are not met, the process proceeds to S7500.

As an example, the judgement can be performed by setting a threshold. In this case, the input is the loss data calculated in the previous steps, including intra-class loss data and inter-class loss data. Judgment can be made by comparing the loss data with a set threshold, such as, whether the current loss is greater than a given threshold. If the current loss is less than or equal to the given threshold, then the training ends.

According to an implementation, the set threshold may be thresholds set for intra-class loss data and inter-class loss data respectively, and as long as any one of the intra-class loss data and the inter-class loss data is less than or equal to a corresponding threshold, then the training ends. According to another implementation, the set threshold may be an overall loss threshold, the overall loss value of the intra-class loss data and the inter-class loss data is compared with the overall loss threshold, and the training ends if the overall loss value is less than the overall loss threshold. The overall loss value may be various combinations of inter-class loss data and inter-class loss data, such as sum, weighted sum, and the like thereof.

As another example, the judgement can be performed by setting a predetermined number of training iterations, such as whether the current number of training iterations reaches the predetermined number of training iterations. In this case, the input is a count of the training iterations that have been performed, and the training ends when the number of training iterations has reached the predetermined number of training iterations.

Otherwise, when none of the above-mentioned predetermined conditions is satisfied, the training process in the next iteration preceeds. For example, if the loss data is greater than a predetermined threshold and the number of iterations is less than the predetermined number of training iterations, the process in the next training iteration continues.

S7500: Update convolutional neural network parameters

In this step, the input is the joint loss calculated in S7300, and the weight function according to the present disclosure is used to update the parameters of the convolutional neural network model.

Specifically, according to the updating function based on the weight function of the present disclosure, for example, the partial derivative functions (Eq. (5) to (11)) as described above, the gradient of the current loss with respect to the output layer of the convolutional neural network is calculated and is used to update the convolutional neural network parameters by the back-propagation algorithm, and the updated neural network is transmitted back to the S7200.

S7600: Output the trained CNN model

In this step, the current parameters of all layers in the CNN model structure serve as the trained model, so that an optimized neural network model can be obtained.

In this embodiment, both the proposed intra-class loss function and inter-class loss function are used to cooperatively control the gradient descent speed, so that a good balance can be found between the contributions of the intra-class loss and the inter-class loss, and a more generalized model can be trained.

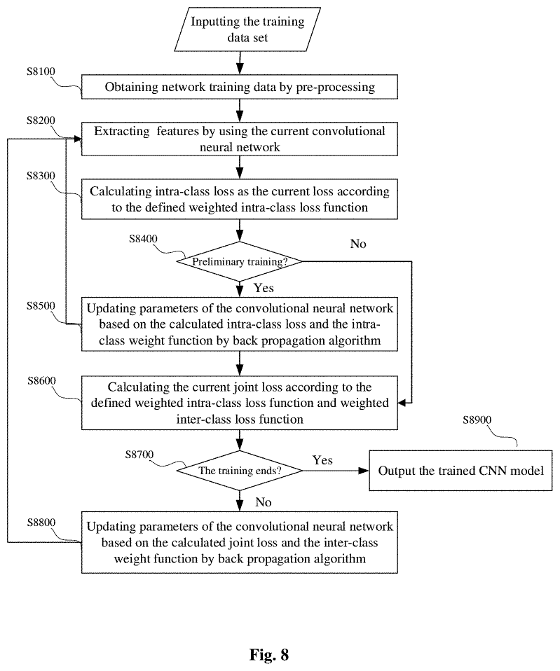

FIG. 8 shows a flowchart of convolutional neural network model training using a joint loss function proposed by the present disclosure according to a second embodiment of the present disclosure. In this embodiment, a stepwise training of a convolutional neural network model is performed by using the joint loss function proposed by the present disclosure. The model training process according to the second embodiment of the present disclosure includes the following steps.

S8100: Obtain network training data through pre-processing

The operation of this step is the same as or similar to that of the S7100, and will not be described in detail here.

S8200: Feature extraction using a current convolutional neural network

The operation of this step is the same as or similar to that of the S7200, and will not be described in detail here.

S8300: Calculate the intra-class loss as the current loss according to the proposed weighted intra-class loss function.

The input are the image features that have been extracted and the last fully connected layer of the convolutional neural network, and then the current intra-class loss is calculated according to the weighted intra-class loss function of the present disclosure. The weighted intra-class loss function can be defined as in the formula (2) described above, which will not be described in detail here.

S8400: Determine whether it is a preliminary training process

In this step, it is possible to determine whether it is a preliminary training based on certain preset conditions, and the preset conditions may include a loss threshold condition, an iteration number condition, a gradient descent speed condition, and the like. If at least one of the above conditions is met, it can be judged that the preliminary training can end, and the process proceeds to S8600. If none of the preset conditions is met, it is judged that the preliminary training needs to continue, and the process proceeds to S8500.

As an example, if any of the following is met: the current gradient descent speed is less than or equal to a given threshold, the current intra-class loss is less than a given threshold, or the current number of training iterations has reached a given number of preliminary training iterations, it can be judged that the preliminary training can end and the process can go to S8600 for post training operation, where the weighted inter-class loss function will be used for training.

As an example, in a case that none of the above conditions may be met, that is, the gradient descent speed is greater than a given threshold, the current intra-class loss is greater than a given threshold, and the current number of training iterations does not reach a given number of preliminary training iterations, it is necessary to continue the preliminary training and the process proceed to S8500.

S8500: Update parameters of the convolutional neural network by using a backpropagation algorithm based on the calculated intra-class loss and intra-class weight function

In this step, the input is the intra-class loss calculated in S8300. The gradient of the current intra-class loss with respect to the output layer of the convolutional neural network needs to be first calculated based on a re-derived partial derivative formula, and then the parameters of the convolutional neural network model can be updated by the back-propagation algorithm, and the updated parameters of the neural network model is returned to S8200. The derived partial derivative formulas are as follows:

$$\begin{matrix}\frac{\partial {L}_{SFace}}{\partial {x}_{i}} = - {r}_{intra} ( {θ}_{{y}_{i}} ) \frac{\partial cos ( {θ}_{{y}_{i}} )}{\partial {x}_{i}} & ( 30 ) \\ \frac{\partial {L}_{SFace}}{\partial {w}_{{y}_{i}}} = - {r}_{intra} ( {θ}_{{y}_{i}} ) \frac{\partial cos ( {θ}_{{y}_{i}} )}{\partial {w}_{{y}_{i}}} & ( 31 ) \\ \frac{\partial cos ( {θ}_{{y}_{i}} )}{\partial {x}_{i}} = \frac{1}{‖ {x}_{i} ‖} ( \frac{{w}_{{y}_{i}}}{‖ {w}_{{y}_{i}} ‖} - cos ( {θ}_{{y}_{i}} ) \frac{{x}_{i}}{‖ {x}_{i} ‖} ) & ( 32 ) \\ \frac{\partial cos ( {θ}_{{y}_{i}} )}{\partial {{w}_{y}}_{i}} = \frac{1}{‖ {{w}_{y}}_{i} ‖} ( \frac{{x}_{i}}{‖ {x}_{i} ‖} - cos ( {θ}_{{y}_{i}} ) \frac{{w}_{{y}_{i}}}{‖ {w}_{{y}_{i}} ‖} ) & ( 33 )\end{matrix}$$

S8600: After the parameters of the training model have been optimized for intra-class loss, the parameters of the training model will be optimized for inter-class loss.

As an example, the current joint loss can be calculated by using the proposed weighted intra-class loss function and weighted inter-class loss function. Specifically, the input are the extracted image features and the last fully connected layer of the convolutional neural network, and then the current intra-class loss and inter-class loss are calculated respectively according to the proposed joint weighted loss function to obtain the joint loss. Specific loss function definitions can be seen from the introduction of formulas (2) to (4) above.

Alternatively, as an example, the inter-class loss can be calculated by means of the weighted inter-class loss function proposed in the present disclosure as described above, and then the sum of the calculated inter-class loss and the intra-class loss at the end of the preliminary training is used as the current joint loss.

S8700: Determine whether to end the training process

In this step, it can be judged whether to end the training based on some pre-set conditions. The preset conditions may include a loss threshold condition, an iteration number condition, a gradient descent speed condition, and the like. If at least one of the conditions is met, the training can end, and the process proceeds to S8900. If none of the preset condition is met, the process proceeds to S8800.

The specific operation of this step may be the same as or similar to that of the foregoing step S7400, and will not be described in detail here.

S8800: Update parameters of the convolutional neural network

In this step, the input is the joint loss calculated in S8600. According to the partial derivative functions (formula (5)˜formula (11)) derived hereinbefore, the gradient of the current inter-class loss with respect to the output layer of the convolutional neural network is first calculated, and then the parameters of the convolutional neural network model are updated by using a back-propagation algorithm, and the updated parameters of the convolutional neural network model parameters are returned to S8200 for the next iterative training.

As an example, preferably, in this case, steps S8300-S8500 in the next iteration process can be directly omitted, and the process can directly proceed to step S8600 from step S8200, thereby simplifying the training process. For example, an indicator may be added to the data transmission after the end of the preliminary training to indicate the end of the preliminary training, and then if such an indicator is identified during the iterative training process, the preliminary training process can be skipped.

As an example, step S8200 may further include an indicator detection step, which is used to detect whether there is an indicator indicating the end of the preliminary training. As an example, after it is judged that the preliminary training ends in step S8400, an indicator indicating the end of the preliminary training may be fed back to step S8200, so that in the feedback updating operation of the post training, if the indicator is detected, the preliminary training process will be skipped. As another example, after it is judged that the preliminary training ends in step S8400, an indicator indicating the end of the preliminary training may be added to the data stream when the process proceeds to the post training, and the indicator is fed back to Step S8200 in the feedback updating operation of the post-training, when such indicator is detected in step S8200, the preliminary training process may be skipped.

S8900: Output the trained CNN model.

This step is the same as or similar to the operation of step S7600, and will not be described in detail here.

Compared with the embodiment 1, the embodiment 2 simplifies the parameter adjustment process for the weight functions and accelerates the training of the model. Preferably, an intra-class loss weight function which is optimal for the current data set is firstly found, and the model training process is constrained by the intra-class loss so that the joint loss can drop to a certain extent through quick iteratation; then an inter-class weight function which is optimial for the current data set and the joint loss can be found, the model training process is finely constrained by the intra-class loss and inter-class loss at the same time, so as to obtain the final training model quickly.

It should be noted that the flow shown in the above flowchart mainly corresponds to a case that the parameters of the intra-class weight function and the inter-class weight function are kept unchanged, and as described above, the parameters of intra-class weight function and the inter-class weight function can be further adjusted, so as to further optimize the design of the weight functions.

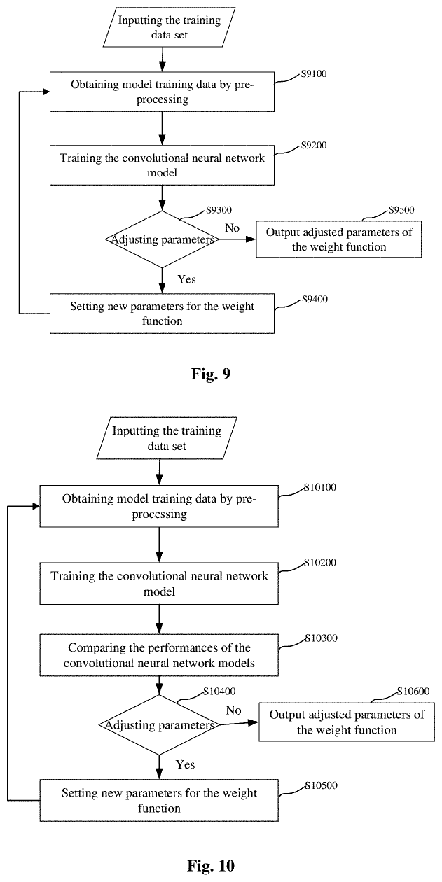

A third embodiment according to the present disclosure will be described below with reference to the drawings. FIG. 9 illustrates an adjustment process for weight function parameters according to a third embodiment of the present disclosure.

S9100: Obtain network training data through pre-processing

The operation of this step is the same as or similar to that of the S7100, and will not be described in detail here.

S9200: Convolutional neural network model training

This step may employ the operation according to any one of the first and second embodiments to perform convolutional neural network model training to obtain an optimized convolutional neural network model according to the present disclosure.

S9300: Judge whether to adjust the weight function parameters

In this step, it is possible to judge whether parameter adjustment is intended to be made based on certain pre-set conditions, and the pre-set conditions may include adjustment times condition, convolutional neural network performance condition, and the like. If at least one of the above conditions is met, it can be judged that the adjustment operation can end, and the process proceeds to S9500. If none of the pre-set conditions are met, it is judged that the adjustment operation needs to continue, and the process proceeds to S9400.

As an example, when the times of parameter adjustment performed has reached a predetermined times of adjustment, or the performance of the current convolutional neural network model is inferior to the performance of the previous convolutional neural network model, it is considered that no further parameter adjustment operation is needed, that is, the adjustment operation can end. Otherwise, if the times of parameter adjustment has not reached the predetermined times of adjustment and the performance of the current convolutional neutral network model is better than the performance of the previous convolutional neural network model, it is judged that the adjustment needs to continue.

S9400: Set new weight function parameters

In this step, it can continue to adjust the parameters according to a specific parameter adjustment manner, until the predetermined adjustment times is reached or the training result is no longer better.

As an example, the specific parameter adjustment manner can be that the parameter adjustment is performed according to a certain rule, for example, the parameter can increase or decrease with a specific step size or following a specific function. As another example, the parameter adjustment may be performed in compliance with the previous adjustment manner. As an example, the adjustment for parameters of the weight function may be performed as described above.

S9500: Output adjusted parameters of the weight function

In this step, the adjusted parameters of the weight function are output, so that a more optimized weight function can be obtained, and thereby the performance of subsequent convolutional neural network model training can be improved.

A fourth embodiment according to the present disclosure will be described below with reference to the accompanying drawings, and FIG. 10 illustrates an adjustment process for weight function parameters according to the fourth embodiment of the present disclosure.

S10100: Obtain network training data through pre-processing

The operation of this step is the same as or similar to that of S7100, and will not be described in detail here.

S10200: Convolutional neural network model training

This step may employ the operation according to any one of the first and second embodiments to perform convolutional neural network model training to obtain an optimized convolutional neural network model according to the present disclosure.

It should be noted that a parameter of the weight function is set with two initial values, so in this step, the determined convolutional neural network models also may be two convolutional neural network models corresponding to the two parameter values one-to-one.

S10300: Compare the performances of the two convolutional neural network models to select a convolutional neural network model with better performance.

S10400: Judge whether to adjust the weight function parameters

In this step, for the convolutional neural network model with better performance as selected in S10300, it is possible to judge whether parameter adjustment is intended to be made based on certain preset conditions. The preset conditions may include adjustment times condition, convolutional neural network performance condition, and the like. If at least one of the above conditions is met, it can be judged that the adjustment operation can end, and the process proceeds to S10600. If none of the preset conditions is satisfied, it is judged that the adjustment operation needs to continue, and the process proceeds to S10500. The operation in this step is the same as or similar to the previous step S9300, and will not be described in detail here.

S10500: Set new weight function parameters

In this step, the parameter adjustment continues according to a specific parameter adjustment mode until the preset adjustment times is reached or the training result is no longer better. The operation of this step is the same as or similar to the previous step S9400, and will not be described in detail here.

S10600: Output the parameters of the adjusted weight function

In this step, the parameters of the adjusted weight function are output, so that a more optimized weight function can be obtained, and thereby improve the performance of subsequent convolutional neural network model training.

It should be noted that in the above embodiment, the adjustment for one parameter is mainly introduced, and for the adjustment for two or more possible parameters in the weight function, for example, various manners can be adopted, such as the various manners described above.

According to the implementation of the present disclosure, in a case where the loss function includes both an intra-class loss function and an inter-class loss function, parameter adjustment is required for the weight function for the intra-class loss and the weight function for the inter-class loss. As an implementation, the parameters of the weight function for the intra-class loss can be adjusted first, and then the parameters of the weight function for the inter-class loss can be adjusted. As another implementation, the parameters of the weight function for intra-class loss and the weight function for inter-class loss can be adjusted simultaneously. The specific adjustment processes for the parameters of each function can be implemented in various ways.

As an example, after the initial parameters of the intra-class and inter-class weight functions are set, the aforementioned convolutional neural network model training is performed. After a predetermined number of iterations is performed or the loss meets the threshold requirement, then the parameters for the intra-class weight function are further adjusted, until parameters that cannot further optimize the loss data determined by the convolutional neural network model can be found. It should be noted that in this case, the inter-class weight function can maintain its initial parameters. Then, based on the optimized intra-class weight function, the parameters of the inter-class weight function are adjusted with operations substantially similar to that in the preliminary training, until parameters that cannot further optimize the loss data determined by the convolutional neural network model can be found. Therefore, the optimal intra-class weight function and inter-class weight function can be finally determined, and the optimal convolutional neural network model can also be determined.

As another example, it can be judged whether the parameter adjustment is required after a round of iterative training ends, and if the adjustment is required, the values of the parameter to be adjusted, such as values for both the intra-class weight function and the inter-class weight functions, are set. Based on this, a new round of iterative training is performed until the parameter adjustment is completed.

It should be noted that the training of the convolution application network model as described in the above embodiment belongs to offline training, that is, the training data set/image set that has been selected is used for model training, and the trained model can be directly used for face/object recognition or verification. According to the present disclosure, the convolutional neural network model can also be trained online. The online training process means that in a process of using the trained model for face recognition/verification, at least some of the recognized pictures can be supplemented to the training image set, so that the model training and update optimization can be performed during the recognition process, and the obtained model is further improved, which can be more suitable for the image set to be recognized, and thereby achieve a good recognition effect.

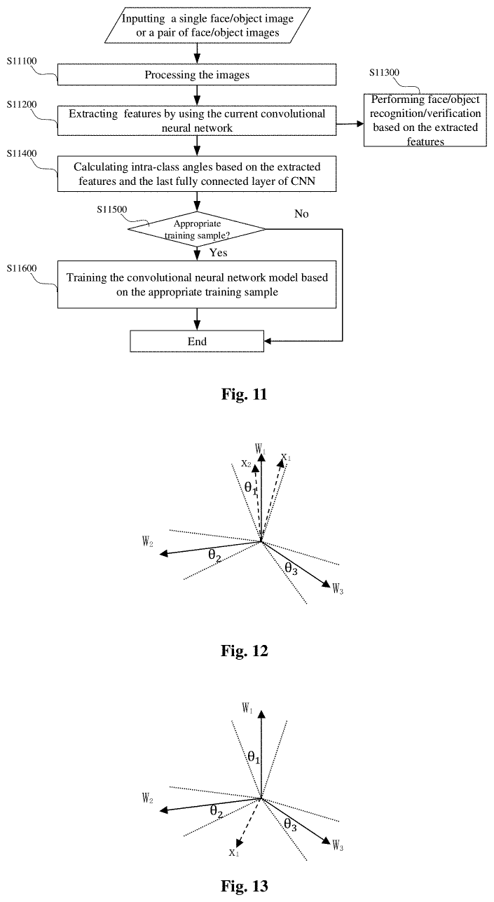

A fifth embodiment according to the present disclosure will be described in detail below, which relates to the online training of a convolutional neural network model. FIG. 11 shows a flow of online learning and updating a trained convolutional neural network model in an application system by using the proposed loss function according to the fifth embodiment of the present disclosure.

S11100: Pre-process an output face/object image to be recognized/verified

In this step, the input is an original image with areal mark of the objector face, and then the input original image can be converted into training data that meets requirements of the convolutional neural network by means of an existing series of pre-processing operations, which can include face or object detection, face or object alignment, image augmentation, image normalization, etc., so as to meet the requirements of convolutional neural network models.

S11200: Use current convolutional neural network to extract features

This step is basically the same as the feature extraction operation in the foregoing embodiment, and will not be described in detail here.

S11300: Face/object recognition or verification based on extracted features

In this step, the face/object is identified or verified based on the extracted image features. The operation here can be performed in a variety of ways known in the art, which will not be described in detail here.

S11400: Calculate the angle between the extracted features and the fully connected layer of the convolution neutral network model

In this step, the input are an extracted image feature and a weight matrix for the last fully connected layer of the convolutional neural network, and then the angle between the currently extracted image feature and each dimension of the weight matrix is calculated according to a defined angle calculation formula. The angle calculation formula is defined specifically as follows:

$${θ}_{j} = arccos ( \frac{{w}_{j}^{T} x}{‖ {w}_{j} ‖ ‖ x ‖} ) \qquad ( 34 )$$

Among them, x is the extracted image feature, W={W₁, W₂, . . . , W_{C}}∈ [symbol] ^{d×C} is the weight matrix for the current fully connected layer, W is the j-th weight vector, indicating a target feature center of the j-th object of the currently trained CNN model.

S11500: Judge whether it is a suitable training sample

In this step, the input is the angle information calculated in the previous step. It can be judged whether the input image is a suitable training sample based on some preset judgment conditions. A suitable training sample means that based on the calculated angle, it can be judged that the input image does not belong to any object in the original training set, or although belonging to an object in the original training set, but the feature of the input image being at a distance from the feature center of the object, which indicates that the image is a sample which is relatively difficult to be recognized for the object, that is, a suitable training sample.

The preset condition may mean whether an angular distance between a feature of the input image and a feature center of a specific object is greater than or equal to a specific threshold. If the distance is greater than or equal to the specific threshold, the training sample may be considered as a suitable training sample.

As an example, if an input image sample is identified as not belonging to any category in the convolutional neural network model, the image sample may belong to a new object category and is necessarily suitable to be a training sample. As an example, if the input image sample is identified as belonging to a certain category of the convolutional neural network model, but the angular distance (angle value) between the feature of the image sample and the feature center of the category is greater than a predetermined threshold, it can be judged that the input image sample is suitable to be a training sample.

It should be noted that the above steps S11300 and S11400 may be combined together. Specifically, when face/object recognition is performed, if it is identified that it does not belong to any object in the original training set, the angular distance calculation is no longer performed, and when it is identified that it belongs to an object in the original training set, only the angular distance between it and the feature center of the object is calculated. This can appropriately simplify the calculation process and reduce the calculation overhead.

FIG. 12 shows a schematic diagram of a case that an input image belongs to a suitable training sample for a certain object in a training data set. As shown in FIG. 12, xᵢ is the extracted image feature, Wⱼ is the target feature center of the j-th object of the current CNN model. If a condition is met, the input image is a suitable training sample for a certain object, for example, in FIG. 12, x₁ is a training sample for object 1; otherwise, it is not a suitable training sample, for example, in FIG. 12, it is judged that x₂ is not a training sample for object 1.

FIG. 13 shows a schematic diagram of a case that the input image is a suitable training sample for a new object.

In this step, if it is determined that the image sample is a suitable training sample, go to step S11600, otherwise end directly.

S11600: Use the newly determined suitable training samples to train the object recognition model.

In particular, the newly determined appropriate training samples can be used as a new training set, and then the model training operation according to the present disclosure is used for model training. As an example, the model training operations described in the first and second embodiments of the present disclosure may be used to perform model training based on the new training set, and the parameters of the weight functions for training the model may also be adjusted according to the third and fourth embodiments of the present disclosure.

According to one implementation, the training performed in this step may be performed only on the determined appropriate training samples. According to another implementation, the training performed in this step may be performed on a combined training set comprising the determined appropriate training samples and the original training set.

According to one implementation, the training performed in this step can be performed in real time, that is, the model training is performed whenever a new suitable training sample is determined. According to another implementation, the training performed in this step may be performed periodically, for example, after a specific number of new suitable training samples are accumulated, the model training is performed.

As an example, in a case where the suitable training sample is that for an object included in the original training data set, the model training is performed through the following operations. Specifically, based on the features of the training sample, the current joint loss is calculated according to the weighted intra-class loss function and the weighted inter-class loss function of the present disclosure, and the parameters of the convolutional neural network are updated by a back propagation algorithm based on the calculated joint loss as well as the intra-class and inter-class weight functions. The updated neural network is returned to S11200 for the next recognization/verification process.

As another example, in a case where a suitable training sample is anew training sample that does not belong to any object of the original training data set, the model training may be performed through the following operations. Specifically, firstly, the weight matrix for the last fully connected layer of the CNN is adjusted according to extracted features. In this step, the input are the features of the judged new object and [symbol] the weight matrix for the current fully connected layer W={W₁, W₂, . . . , W_{C}}∈ [symbol] ^{d×C}, and the weight matrix shall be extended to W′={W₁, W₂, . . . , W_{C}, W_{C+1}}∈ [symbol] ^{d×(C+1)}, so that W_{C+1} can represent the target feature center of the new object. The simplest adjustment method is to directly take the feature of the new object as the target feature center of the new object. A more reasonable adjustment method is to find a vector W_{C+1} that is approximately orthogonal to the original weight matrix near the feature of the new object and add it into the original weight matrix as the feature center of the new object. Then based on the features of the training samples, the current joint loss is calculated based on the weighted intra-class loss function and weighted inter-class loss function according to the present disclosure, and the parameters of the convolutional neural network is updated by using the back-propagation algorithm based on the calculated joint loss as well as the intra-class and inter-class weight functions. The updated neural network is returned to S11200 for the next recognization/verification process.

The fifth embodiment can continuously optimize the model by using the online learning method in the actual application process, so that the model has better adaptability to real application scenarios. In the actual application process, the online learning method can be used to enhance the recognition ability of the model, so that the model has better flexibility for real application scenarios.

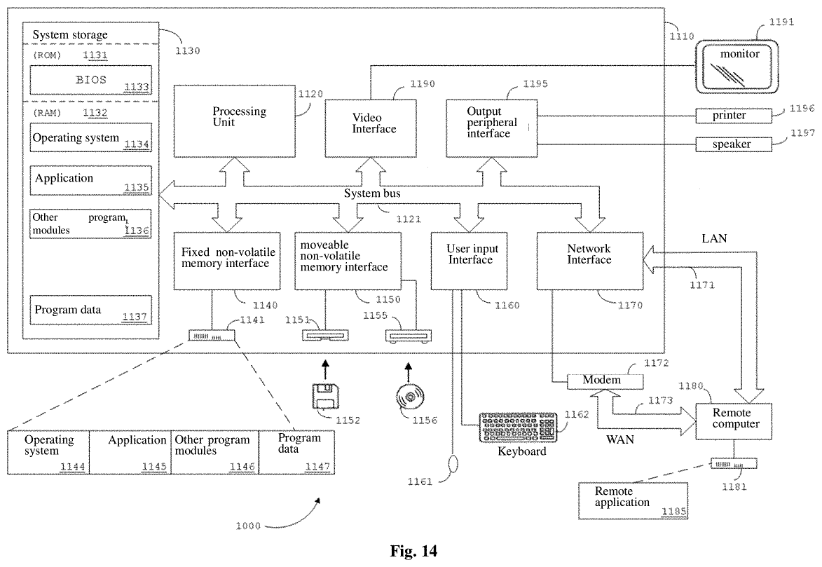

FIG. 14 is a block diagram showing an exemplary hardware configuration of a computer system 1000 that can implement an embodiment of the present disclosure.

As shown in FIG. 14, the computer system comprises a computer 1110. The computer 1110 includes a processing unit 1120, a system storage 1130, a non-removable non-volatile memory interface 1140, a removable non-volatile memory interface 1150, a user input interface 1160, a network interface 1170, a vide interface 1190, and an output peripheral interface 1195, which are connected via a system bus 1121.

The system storage 1130 includes a ROM (readable only memory) 1131 and a RAM (random accessible memory)1132. BIOS (basic input and output system) 1133 resides in ROM 1131. An operating system 1134, application program 1135, other program module 1136 and some program data 1137 reside in the RAM 1132.

A non-removable non-volatile memory 1141, such as a hard disk, is connected to the non-removable non-volatile memory interface 1140. The non-removable non-volatile memory 1141 may store, for example, an operating system 1144, an application program 1145, other program modules 1146, and some program data 1147.

Removable non-volatile memory (such as a floppy disk driver 1151 and a CD-ROM driver 1155) is connected to the removable non-volatile memory interface 1150. For example, a floppy disk 1152 may be inserted into the floppy disk driver 1151, and a CD (Compact Disc) 1156 may be inserted into the CD-ROM driver 1155.

Input devices such as a mouse 1161 and a keyboard 1162 are connected to the user input interface 1160.

The computer 1110 may be connected to a remote computer 1180 through a network interface 1170. For example, the network interface 1170 may be connected to a remote computer 1180 via a local area network 1171. Alternatively, the network interface 1170 may be connected to a modem (modulator-demodulator) 1172, and the modem 1172 is connected to a remote computer 1180 via a wide area network 1173.

The remote computer 1180 may include a storage 1181, such as a hard disk, that stores remote applications 1185.

The video interface 1190 is connected to a monitor 1191.

The output peripheral interface 1195 is connected to a printer 1196 and a speaker 1197.

The computer system shown in FIG. 14 is merely illustrative and is in no way intended to limit the invention, its application, or its usage.

The computer system shown in FIG. 14 may be implemented as an isolated computer or as a processing system in an apparatus for any embodiment, in which one or more unnecessary components may be removed or one or more additional components may be added.

The invention can be used in many applications. For example, the present disclosure can be used to monitor, identify, and track objects in still images or mobile videos captured by a camera, and is particularly advantageous for camera-equipped portable devices, (camera-based) mobile phones, and the like.

It should be noted that the methods and devices described herein may be implemented as software, firmware, hardware, or any combination thereof. Some components may be implemented, for example, as software running on a digital signal processor or microprocessor. Other components may be implemented, for example, as hardware and/or application specific integrated circuits.

In addition, the methods and systems of the present disclosure can be implemented in a variety of ways. For example, the methods and systems of the present disclosure may be implemented in software, hardware, firmware, or any combination thereof. The order of the steps of the method described above is merely illustrative, and unless specifically stated otherwise, the steps of the method of the present disclosure are not limited to the order specifically described above. In addition, in some embodiments, the present disclosure may also be embodied as a program recorded in a recording medium, including machine-readable instructions for implementing a method according to the present disclosure. Therefore, the present disclosure also encompasses a recording medium storing a program for implementing the method according to the present disclosure.

Those skilled in the art will appreciate that the boundaries between the operations described above are merely illustrative. Multiple operations can be combined into a single operation, a single operation can be distributed among additional operations, and operations can be performed with at least partially being overlapped in time. Moreover, alternative embodiments may include multiple instances of a particular operation, and the order of operations may be changed in other various embodiments. However, other modifications, changes, and substitutions are also possible. Accordingly, the description and drawings of the present disclosure are to be regarded as illustrative rather than restrictive.

In addition, the embodiments of the present disclosure may also include the following schematic examples (EE).

EE 1. An apparatus for optimizing a neural network model for object recognition, comprising:

a loss determination unit configured to determine loss data for features extracted from a training image set using the neural network model and a loss function with a weight function, and

an updating unit configured to perform an updating operation for parameters of the neural network model based on the loss data and an updating function,

wherein the updating function is derived based on the loss function with the weight function of the neural network model, and the weight function and the loss function change monotonically in a specific value interval in the same direction.

EE 2. The apparatus according to EE 1, wherein the weight function and the loss function each is a function of angle, and wherein the angle is an intersection angle between an extracted feature mapped onto a hyperspherical manifold and a specific weight vector in a fully connected layer of the neural network model, and wherein the specific value interval is a specific angle value interval.

EE 3. The apparatus according to EE 2, wherein the specific angle value interval is [0, π/2], and the weight function and the loss function change monotonically and smoothly in the specific angle value interval in the same direction.

EE 4. The apparatus according to EE 2, wherein the loss function is a cosine function of the intersection angle.

EE 5. The apparatus according to EE 1, wherein the loss function comprises an intra-class angle loss function, and wherein an intra-class angle is an intersection angle between an extracted feature mapped onto a hyperspherical manifold and a weight vector in a fully connected layer of the neural network model representing a truth object, and

wherein the updating function is determined based on the intra-class angle loss function and an intra-class angle weight function.

EE 6. The apparatus according to EE 1, wherein the intra-class angle loss function is an intra-class angle cosine function that takes negative, and the intra-class angle weight function is a function which is non-negative and increases smoothly and monotonically as the angle increases in a specific value interval.

EE 7. The apparatus according to EE 1, wherein the value interval is [0, π/2], and the intra-class angle weight function has a horizontal cutoff point near 0.

EE 8. The apparatus according to EE 1, wherein the loss function further comprises an inter-class angle loss function, and wherein an inter-class angle is an intersection angle between an extracted feature mapped onto a hyperspherical manifold and another weight vector in a fully connected layer of the neural network model, and

wherein the updating function is determined based on the inter-class angle loss function and an inter-class angle weight function.

EE 9. The apparatus according to EE 1, wherein the inter-class angle loss function is a sum of inter-class angle cosine functions, and the inter-class angle weight function is a function which is non-negative and decreases smoothly and monotonically as the angle increases in a specific value interval.

EE 10. The apparatus according to EE 1, wherein the value interval is [0, π/2], and the inter-class angle weight function has a horizontal cut-off point near π/2.

EE 11. The apparatus of EE 1, wherein the updating function is based on the weight function and a partial derivative of the loss function.

EE 12. The apparatus according to EE 1, wherein the updating unit is further configured to multiply the partial derivative of the loss function and the weight function to determine an updating gradient for updating the neural network model.

EE 13. The apparatus according to EE 12, wherein the updating unit is further configured to update the parameters of the neural network model using a back propagation method and the determined updating gradient.

EE 14. The apparatus according to EE 1, wherein after the neural network model is updated, the loss determination unit and the updating unit operate by using the updated neural network model.

EE 15. The apparatus according to EE 1, wherein the updating unit is configured to, when the determined loss data is greater than a threshold and the number of iteration operations performed by the loss determination unit and the updating unit does not reach a predetermined iteration number, perform updating by means of the determined updating gradient.

EE 16. The apparatus according to EE 1, wherein the loss data determination unit is further configured to determine the loss data by using a combination of the weight function and the loss function of the neural network model.

EE 17. The apparatus according to EE 1, wherein a combination of the weight function and the loss function of the neural network model is a product of the weight function and the loss function of the neural network model.

EE 18. The apparatus according to EE 1, further comprising an image feature acquisition unit configured to acquire image features from a training image set using the neural network model.

EE 19. The apparatus according to EE 1, wherein the neural network model is a deep neural network model, and the acquired image features are depth-embedded features of the images.

EE 20. The apparatus of EE 1, wherein the parameters of the weight function can be adjusted based on loss data determined on a training set or a validation set.

EE 21. The apparatus according to EE 20, wherein after a first parameter and a second parameter for the weight function are individually set for performing a loss data determination operation and an updating operation which are iterative, two parameters around one of the first and second parameters which causes the loss data to be better are selected as the first parameter and the second parameter for the weight function in the next iteration operation.

EE 22. The apparatus according to EE 20, wherein the weight function is a Sigmoid function or its variant function having similar characteristics, and the parameters include a slope parameter and a horizontal intercept parameter.

EE 23. A method for training a neural network model for object recognition, comprising:

a loss determination step of determining loss data for features extracted from a training image set using the neural network model and a loss function with a weight function, and

an update step of performing an updating operation for parameters of the neural network model based on the loss data and an updating function,

wherein the updating function is derived based on the loss function with the weight function of the neural network model, and the weight function and the loss function change monotonically in a specific value interval in the same direction.

EE 24. A device, comprising

at least one processor; and

at least one storage device on which instructions are stored, the instructions, when executed by the at least one processor, causing the at least one processor to perform the method of EE 23.

EE 25. A storage medium storing instructions that, when executed by a processor, cause execution of the method of EE 23.

Although the invention has been described with reference to example embodiments, it should be understood that the invention is not limited to the disclosed example embodiments. The scope of the following claims is to be accorded the broadest interpretation so as to encompass all such modifications and equivalent structures and functions.

Although some specific embodiments of the present disclosure have been described in detail through examples, those skilled in the art should understand that the above examples are only for the purpose of illustration and are not intended to limit the scope of the present disclosure. The embodiments disclosed herein may be arbitrarily combined without departing from the spirit and scope of the present disclosure. Those skilled in the art should also understand that various modifications can be made to the embodiments without departing from the scope and spirit of the present disclosure.

What is claimed is:

1. An apparatus for optimizing a neural network model for object recognition, comprising:
a loss determination unit configured to determine loss data for features extracted from a training image set using the neural network model and a loss function with a weight function, and
an updating unit configured to perform an updating operation for parameters of the neural network model based on the loss data and an updating function,
wherein the updating function is derived based on the loss function with the weight function of the neural network model, and the weight function and the loss function change monotonically in a specific value interval in the same direction.

2. The apparatus according to claim 1, wherein the weight function and the loss function each is a function of angle, and wherein the angle is an intersection angle between an extracted feature mapped onto a hyperspherical manifold and a specific weight vector in a fully connected layer of the neural network model, and wherein the specific value interval is a specific angle value interval.

3. The apparatus according to claim 2, wherein the specific angle value interval is [0, π/2], and the weight function and the loss function change monotonically and smoothly in the specific angle value interval in the same direction.

4. The apparatus according to claim 2, wherein the loss function is a cosine function of the intersection angle.

5. The apparatus according to claim 1, wherein the loss function comprises an intra-class angle loss function, and wherein an intra-class angle is an intersection angle between an extracted feature mapped onto a hyperspherical manifold and a weight vector in a fully connected layer of the neural network model representing a truth object, and
wherein the updating function is determined based on the intra-class angle loss function and an intra-class angle weight function.

6. The apparatus according to claim 1, wherein the intra-class angle loss function is an intra-class angle cosine function that takes negative, and the intra-class angle weight function is a function which is non-negative and increases smoothly and monotonically as the angle increases in a specific value interval.

7. The apparatus according to claim 1, wherein the value interval is [0, π/2], and the intra-class angle weight function has a horizontal cutoff point near 0.

8. The apparatus according to claim 1, wherein the loss function further comprises an inter-class angle loss function, and wherein an inter-class angle is an intersection angle between an extracted feature mapped onto a hyperspherical manifold and another weight vector in a fully connected layer of the neural network model, and
wherein the updating function is determined based on the inter-class angle loss function and an inter-class angle weight function.

9. The apparatus according to claim 1, wherein the inter-class angle loss function is a sum of inter-class angle cosine functions, and the inter-class angle weight function is a function which is non-negative and decreases smoothly and monotonically as the angle increases in a specific value interval.

10. The apparatus according to claim 1, wherein the value interval is [0, π/2], and the inter-class angle weight function has a horizontal cut-off point near π/2.

11. The apparatus of claim 1, wherein the updating function is based on the weight function and a partial derivative of the loss function.

12. The apparatus according to claim 1, wherein the updating unit is further configured to multiply the partial derivative of the loss function and the weight function to determine an updating gradient for updating the neural network model.

13. The apparatus according to claim 12, wherein the updating unit is further configured to update the parameters of the neural network model using a back propagation method and the determined updating gradient.

14. The apparatus according to claim 1, wherein after the neural network model is updated, the loss determination unit and the updating unit operate by using the updated neural network model.

15. The apparatus according to claim 1, wherein the updating unit is configured to, when the determined loss data is greater than a threshold and the number of iteration operations performed by the loss determination unit and the updating unit does not reach a predetermined iteration number, perform updating by means of the determined updating gradient.

16. The apparatus according to claim 1, wherein the loss data determination unit is further configured to determine the loss data by using a combination of the weight function and the loss function of the neural network model.

17. The apparatus according to claim 1, wherein a combination of the weight function and the loss function of the neural network model is a product of the weight function and the loss function of the neural network model.

18. The apparatus according to claim 1, further comprising an image feature acquisition unit configured to acquire image features from a training image set using the neural network model.

19. The apparatus according to claim 1, wherein the neural network model is a deep neural network model, and the acquired image features are depth-embedded features of the images.

20. The apparatus of claim 1, wherein the parameters of the weight function can be adjusted based on loss data determined on a training set or a validation set.

21. The apparatus according to claim 20, wherein after a first parameter and a second parameter for the weight function are individually set for performing a loss data determination operation and an updating operation which are iterative, two parameters around one of the first and second parameters which causes the loss data to be better are selected as the first parameter and the second parameter for the weight function in the next iteration operation.

22. The apparatus according to claim 20, wherein the weight function is a Sigmoid function or its variant function having similar characteristics, and the parameters include a slope parameter and a horizontal intercept parameter.

23. A method for training a neural network model for object recognition, comprising:
a loss determination step of determining loss data for features extracted from a training image set using the neural network model and a loss function with a weight function, and
an update step of performing an updating operation for parameters of the neural network model based on the loss data and an updating function,
wherein the updating function is derived based on the loss function with the weight function of the neural network model, and the weight function and the loss function change monotonically in a specific value interval in the same direction.

24. A device, comprising
at least one processor; and
at least one storage device on which instructions are stored, the instructions, when executed by the at least one processor, causing the at least one processor to perform a method for training a neural network model for object recognition, comprising:
determining loss data for features extracted from a training image set using the neural network model and a loss function with a weight function, and
performing an updating operation for parameters of the neural network model based on the loss data and an updating function,
wherein the updating function is derived based on the loss function with the weight function of the neural network model, and the weight function and the loss function change monotonically in a specific value interval in the same direction.

25. A storage medium storing instructions that, when executed by a processor, cause execution of the method of claim 23.
